(19) United States
(12) Patent Application Publication
(10) Pub. No.: US 2026/0175321 A1
(43) Pub. Date: Jun. 25, 2026

(54) Device and method for determining the focal position with consideration of process gas

(71) Applicant: PRIMES GMBH MESSTECHNIK FÜR DIE PRODUKTION MIT LASERSTRAHLUNG, Pfungstadt (DE)

(72) Inventors: Reinhard KRAMER, Pfungstadt (DE); Stefan WOLF, Groß-Gerau (DE); Johannes RO¿NAGEL, Mainz-Kastel (DE); Marc HÄNSEL, Darmstadt (DE); Roman NIEDRIG, Berlin (DE)

(73) Assignee: PRIMES GMBH MESSTECHNIK FÜR DIE PRODUKTION MIT LASERSTRAHLUNG, Pfungstadt (DE)

(21) Appl. No.: 18/854,016

(22) PCT Filed: Apr. 24, 2023
(86) PCT No.: PCT/EP2023/060696

§ 371 Date: Oct. 3, 2024

(30) Foreign Application Priority Data
Apr. 26, 2022 (DE) 10 2022 109 940.7
Jun. 3, 2022 (DE) 10 2022 114 157.8

(51) Int. Cl. B23K 26/042

(52) U.S. Cl. CPC B23K 26/043

(57) ABSTRACT

The invention relates to a beam analysis apparatus (10) for determining an axial position of a focus (76) of an energy beam (77) of electromagnetic radiation guided in a laser machining optics (100). A beam shaping device (12) is configured to receive a sample beam (70) and to image at least one part of the sample beam (70) on a detector (40) in order to form an intensity distribution (79) on the detector (40). An evaluation device (80) is configured to process electrical signals (64) from the detector (40) and to determine a geometry parameter from the intensity distribution (79). For a more accurate determination of the focal position during on-going machining processes, the evaluation device (80) is configured to receive a cutting gas signal (63), for determining a correction value taking into account the cutting gas signal (63) and for determining the axial position of the focus (76) of the energy beam (77) taking into account the geometry parameter and the correction value. The invention further relates to a system with such a beam analysis apparatus (10) and a method for determining an axial position of a focus (76) of an energy beam (77) guided in a laser machining optics (100).

### TECHNICAL FIELD

The invention relates to a device and a method for determining the axial position of a focus of an energy beam of electromagnetic radiation guided in laser processing optics. The energy beam can particularly be a laser beam. The laser processing optics can particularly be a cutting optics with a cutting gas device. In particular, the invention provides devices and methods which enable the position of the beam focus of processing optics to be determined during an ongoing laser processing process.

### BACKGROUND OF THE INVENTION

In laser material processing, the adjustment and control of the axial focal position of the laser beam relative to the material or workpiece to be processed has a major influence on the quality of the processing process.

In laser cutting processes, it is not only the focus position relative to the workpiece that is important, but also the distance between the workpiece and the cutting nozzle, as the flow dynamics of the cutting gas have a major influence on the result of the cutting process. To maintain a defined distance between the workpiece and the cutting nozzle, capacitive distance measurement and control is known from the state of the art.

However, controlling and/or tracking the distance between the cutting nozzle and the workpiece does not simultaneously ensure a defined axial position of the laser beam focus relative to the workpiece, as the focal position of the laser processing optics can vary independently of this or change unintentionally or uncontrollably.

Modern laser processing systems use lasers with high brilliance and high power, often in the range of several kilowatts. Due to the material properties in the optical elements of laser processing optics, the high laser power leads to heating of the optical elements. This creates a radial temperature gradient in the optical elements, which results in a change in the refractive power of the optical elements due to the temperature dependence of material parameters such as the refractive index. This effect is called thermal focus shift. The effect is intensified by the reaction products and particles of various sizes produced during laser material processing, which can deposit on the processing optics or the protective glass of the processing optics and lead to increased absorption. As a result, particularly the protective glasses often contribute to an undesired and uncontrolled change in the beam focus position of the processing optics.

In addition, laser processing optics can also have devices for the targeted adjustment or variation of the axial focal position. For example, a part of the lens system of the processing optics, in particular the collimator or a lens of the collimator objective, can be arranged to be axially adjustable in order to be able to specifically adjust or also track the axial focal position of the optics.

It is therefore desirable, especially in the case of laser cutting optics, to be able to measure, control and, if necessary, track the axial focal position during the ongoing processing process.

From the state of the art, devices and processing optics are known in which a fraction of the laser beam is decoupled from the optics and the decoupled beam is directed onto a beam analysis device.

WO 2021/156 788 A1, for example, discloses cutting optics in which part of the focused laser beam is decoupled laterally by means of an optical element arranged in front of the cutting nozzle and directed onto a wavefront sensor. The determined wavefront is compared with a reference wavefront. To reduce aberrations, the focal position can be changed by means of adjustable focusing.

Also, a laser processing head is known from DE 10 2011 007 176 A1, in which the laser radiation reflected back from an inclined optical element, in particular a protective glass, is directed onto a detector in order to determine the focus position from the radiation detected by the detector. A device for changing the focus position also enables the focus position to be controlled.

In document DE 10 2017 131 224 A1, a detection of the beam properties based on the measurement of the decoupled reflex at at least two locations offset from each other along the direction of propagation is proposed. Among other things, the focal position can be determined from the determined beam properties. A protective glass inclined to the beam axis is also used here to generate a decoupled reflection.

With the known devices in which a beam portion is decoupled in the focused beam by means of an inclined optical element, it should be noted that, due to the inclined optical element, aberrations, for example astigmatism, can be generated in the focused beam which can have an unfavorable effect on the quality of the beam focus.

For this reason, it has also been proposed to first coaxially reflect the beam portion partially reflected by the optical element back into the optical system and to then decouple the beam portion from the beam path of the optics by means of a second decoupling device arranged within the optical system. The partially reflecting element generating the back reflection, for example the protective glass, can therefore be arranged vertically in the focused beam so that no aberrations are generated in the focused beam. Such an arrangement for beam analysis is disclosed, for example, in DE 10 2007 053 632 B4.

Laser cutting processes are known in which the pressure of a process gas or cutting gas and additionally or alternatively the axial focal position are specifically changed during the processing process. For example, JP H 03023091 A discloses the use of a low pressure of the process gas during the piercing process, while a process gas under high pressure is subsequently supplied during cutting.

Known influences on the focal position of processing optics are thus on the one hand the thermal focus shift in particular and on the other hand also the targeted influencing of the focal position by adjustable optical elements.

Other significant influences on the focal position have not yet been discussed or considered in the prior art.

The known focal position sensors and methods for determining a focal position are inaccurate because the effects of a pressurized process gas, in particular of a cutting gas, on the focal position are not taken into account. The task is therefore to enable a more accurate determination of the focal position, especially for cutting optics.

### SUMMARY OF THE INVENTION

It is therefore the task of the present invention to advantageously further develop the known focal position sensors and methods for determining a focal position and, in particular, to compensate for the effects of a process gas on the focal position determination, thus enabling a particularly accurate determination of the focal position. It is also the task of the present invention to provide particularly robust, accurate, versatile, and compact devices and methods for determining the focal position, which can be used on processing optics and which optionally enable controlling the focal position of processing optics.

The problem is solved with the features listed in the independent claims.

The above problem is solved by a device with the features of claim 1.

For this purpose, according to the invention, a beam analysis device for determining an axial position of a focus is provided, which comprises a focus position sensor and an evaluation device.

Therein, the focus is a focus of an energy beam of electromagnetic radiation guided in laser processing optics. The focus position sensor contains a beam shaping device and a detector.

The beam shaping device is configured to receive a sample beam. The beam shaping device is also configured to image at least part of the sample beam onto the detector by means of the beam shaping device in order to form an intensity distribution on the detector.

The detector comprises a sensor being sensitive to light radiation and having a two-dimensional spatial resolution, which is configured to convert the intensity distribution incident on the detector into electrical signals.

The evaluation device is configured to process the electrical signals of the detector, which represent the intensity distribution on the detector. The evaluation device is also configured to determine a geometry parameter from the intensity distribution. The evaluation device is also configured to receive a cutting gas signal, which represents the pressure of a process gas or a cutting gas. The evaluation device is also configured to determine a correction value taking into consideration the cutting gas signal. The evaluation device is furthermore configured to determine the axial position of the focus of the energy beam, taking into consideration the geometry parameter and the correction value.

The beam analysis device according to claim 1 has the advantage that changes in the focal position caused by a process gas or a cutting gas, in particular under varying and/or high pressure, are compensated for by taking a cutting gas signal into consideration when determining the focal position, and in this way a much more accurate and reliable determination of the focal position during an ongoing processing process is achieved.

Advantageous embodiments are defined by the features mentioned in the dependent claims.

The beam analysis device according to the invention can optionally be further developed by one or more of the features listed below.

The sample beam may be generated by back-reflection of a fraction of the energy beam at an interface of an optical element of the laser processing optics. The optical element can be adjacent to a cavity of a cutting gas device of the laser processing optics. The sample beam can be decoupled from the laser processing optics by means of a decoupling device. The sample beam can be fed to the beam shaping device of the beam analysis device. The cutting gas signal can represent a current pressure of a process gas or cutting gas in the cavity of the cutting gas device.

The beam shaping device and the detector can be arranged together in a housing, which has an opening for introducing the sample beam. The housing can be connectable to the laser processing optics so that the sample beam, which can be decoupled by means of the decoupling device, can be fed to the beam shaping device.

In one embodiment of the beam analysis device, the evaluation device can comprise an input unit for the cutting gas signal, an input unit for the detector signal, a memory unit, and a calculation unit.

The evaluation device can be configured to determine the correction value taking into consideration calibration data stored in the memory unit. The calibration data can describe a change in the geometry parameter as a function of the cutting gas signal.

In a further embodiment of the beam analysis device, the evaluation device can be configured to receive a lens position signal, which represents the axial position of an axially positionable lens or lens group of the laser processing optics. Furthermore, the evaluation device can be configured to determine the axial position of the focus of the energy beam, taking into consideration the geometry parameter, the correction value, and the lens position signal.

The evaluation device can comprise an input unit for the lens position signal.

In a further embodiment of the beam analysis device, the evaluation device can be configured to calculate a focus tracking signal from the determined axial position of the focus of the energy beam, which is a focus actual position, and from a focus target position. Furthermore, the evaluation device can be configured to output the focus tracking signal, which can be transferred directly or via a higher-level control device to a positioning device. The positioning device can be used to adjust the position of an axially positionable lens of the laser processing optics.

The evaluation device can comprise an output unit for the focus tracking signal.

The beam shaping device can comprise an imaging device with at least one optical lens.

In one possible embodiment of the beam analysis device, the beam shaping device can be configured to image the sample beam onto the detector and to form the intensity distribution on the detector with a beam spot that has a diameter Ø. The determination of the geometry parameter by the evaluation device can comprise a determination of the diameter Ø of the beam spot on the detector.

In another possible embodiment of the beam analysis device, the beam shaping device may comprise a lens array for imaging the sample beam onto the detector and for forming the intensity distribution on the detector with a plurality of beam spots having distances a_{N1}, a_{N2}, . . . a_{NM} from one another. The determination of the geometry parameter by the evaluation device can comprise a determination of at least one of the distances a_{N1}, a_{N2}, . . . a_{NM} of the beam spots from one another.

In yet another possible embodiment of the beam analysis device, the beam shaping device can comprise a modulation device for extracting two partial beams from the sample beam. The beam shaping device can also be configured to image the two partial beams onto the detector for forming the intensity distribution on the detector with two beam spots having a distance a from one another. Therein, the determination of the geometry parameter by the evaluation device can comprise a determination of the distance a of the beam spots from one another.

Another embodiment of the beam analysis device is provided in which the beam shaping device can be configured to extract two partial beams from the sample beam in a plane of the partial beam extraction. The two partial beams are a first partial beam and a second partial beam, wherein cross-sections of the two partial beams in the plane of the partial beam extraction are each defined by a partial aperture. The partial apertures are delimited from one another. The centers of the partial apertures have a distance k from one another. A first lateral direction is defined by the distance k of the partial apertures. The term “lateral” refers to directions in planes perpendicular to the respective local optical axis. The beam shaping device can also be configured to image the two partial beams onto the detector in order to form the intensity distribution on the detector with beam spots and to each form at least one beam spot from the first partial beam and at least one beam spot from the second partial beam. The detector can be arranged along a propagation path for the partial beams at a distance s behind the plane of the partial beam extraction. The determination of the geometry parameter by the evaluation device can comprise a determination of a distance a along the first lateral direction between positions of the two beam spots on the detector.

The beam shaping device can be configured to deflect and/or displace at least one of the at least two partial beams in a second lateral direction to form a distance w along the second lateral direction between the two beam spots on the detector. The second lateral direction is oriented transversely to the first lateral direction.

In other words, the beam shaping device can be configured to form the (at least two) partial apertures in the plane of the partial beam extraction for extracting one partial beam at a time. The beam shaping device can, in other words, be set up so that, due to the distance k (in the first lateral direction in the plane of the partial beam extraction) on the detector, the beam spot of one of the at least two partial beams and the beam spot of the other of the at least two partial beams form, along the first lateral direction on the detector, the distance a from one another on the detector, wherein the distance a depends, inter alia, on the axial position of the beam focus.

Furthermore, the beam shaping device can, in other words, be set up so that, due to the deflection and/or displacement of at least one of the two partial beams, the beam spot of one of the at least two partial beams and the beam spot of the other of the at least two partial beams on the detector are additionally offset from one another by the distance w along the second lateral direction on the detector, wherein the second lateral direction on the detector is transverse to the first lateral direction on the detector. The distance a can be small or even zero under certain circumstances.

Due to the additional distance w between the two beam spots on the detector, the two beam spots are still distinguishable even in such a case. For example, the beam shaping device can be set up in such a way that the distance w is so large that the two beam spots only partially overlap (or preferably do not overlap) even if the distance a becomes zero.

Further, a beam analysis device is provided in which the first lateral direction and the local optical axis between the plane of the partial beam extraction and the detector may be changed by beam folding and/or beam deflection.

The beam shaping device can be configured to deflect and/or displace the two partial beams relative to one another. Therein, a difference between the deflections and/or displacements of the two partial beams can be aligned along the second lateral direction to form the distance w along the second lateral direction between the two beam spots on the detector.

The beam shaping device may comprise a beam separator device with at least one partial beam deflector element for deflecting and/or displacing a first of the at least two partial beams in the second lateral direction to form the distance w along the second lateral direction between the two beam spots on the detector.

The optional beam separator device can also comprise at least two partial beam deflector elements for deflecting and/or displacing the two partial beams relative to one another. In this case, a difference between the deflections and/or displacements of the two partial beams is aligned along the second lateral direction to form the distance w along the second lateral direction between the two beam spots on the detector.

The optional beam separator device can include at least one wedge plate as a partial beam deflector element, which can be arranged in alignment with the beam direction in front of or behind one of the partial apertures, and which is configured to deflect the partial beam extracted from the partial aperture by an angular amount in the range from 0.02° to 6°.

The optional beam separator device can include at least one tilted plane-parallel plate or a prism as a partial beam deflector element, which can be arranged in alignment with the beam direction in front of or behind one of the partial apertures, and which is configured to displace the partial beam released from the partial aperture by an amount in the range from 0.05 mm to 3 mm.

The evaluation device can furthermore be configured to determine a lateral position of the overall intensity distribution on the detector and be configured to calculate a lateral position of the focus of the energy beam from the lateral position of the overall intensity distribution and/or to calculate a change in the lateral position of the focus of the energy beam from a change in the lateral position of the overall intensity distribution.

Also, a system can be provided which comprises a beam analysis device and laser processing optics for guiding and focusing the energy beam. The processing optics can comprise a decoupling device for decoupling the sample beam. Furthermore, the beam analysis device may be connectable to the processing optics for receiving the decoupled sample beam.

The above problem is further solved by a method having the features of claim 24.

For this purpose, according to the invention, a beam analysis method for determining an axial position of a focus is also provided. Here, the focus is a focus of an energy beam of electromagnetic radiation guided in laser processing optics. The method comprises at least the following steps:
receiving a sample beam decoupled from the laser processing optics,
imaging at least part of the sample beam onto a detector by means of a beam shaping device in order to form an intensity distribution on the detector,
converting the intensity distribution incident on the detector into electrical signals by means of a sensor of the detector which is sensitive to light radiation and has a two-dimensional

spatial resolution,
processing the electrical signals of the detector, which represent the intensity distribution on the detector,
determining a geometry parameter from the intensity distribution,
receiving a cutting gas signal representing a pressure of a process gas or cutting gas,
determining a correction value taking into consideration the cutting gas signal, and
determining the axial position of the focus of the energy beam, taking into consideration the geometry parameter and the correction value.

The beam analysis method according to the invention can be further developed by one or more of the optional steps listed below.

A possible beam analysis method may additionally comprise the following three steps:
Generating the sample beam by back-reflecting a fraction of the energy beam at an interface of an optical element of the laser processing optics. The optical element can be adjacent to a cavity of a cutting gas device of the laser processing optics.
Decoupling of the sample beam from the laser processing optics by means of a decoupling device.
Feeding the decoupled sample beam to the beam analysis device.

In a further step, the correction value can be determined taking into consideration calibration data.

The calibration data can describe a change in the geometry parameter as a function of the cutting gas signal.

Another possible method may include the following two steps:
Receiving a lens position signal representing the axial position of an axially positionable lens or lens group of the laser processing optics.
Determining the axial position of the focus of the energy beam, taking into consideration the geometry parameter, the correction value, and the lens position signal.

Yet another possible method may include the following two steps:
Calculating a focus tracking signal from the determined axial position of the focus of the energy beam, which is a focus actual position, and from a focus target position.
Providing and transferring the focus tracking signal to a positioning device by means of which a position of an axially positionable lens or lens group of the laser processing optics can be adjusted.

The features, embodiments, modifications, and advantages described with respect to the device apply mutatis mutandis to the method and vice versa.

### DESCRIPTION OF DRAWINGS

FIG. 1 shows an embodiment of the beam analysis device 10 according to the invention. The beam analysis device 10 includes a focal position sensor 13 and an evaluation device 80. The focal position sensor 13 includes a beam shaping device 12 and a detector 40. The beam shaping device 12 is arranged to receive a sample beam 70 propagating along a local optical axis 11. The beam

shaping device 12 and the detector 40 can be arranged together in a housing which has an opening for introducing the sample beam 70. The sample beam 70 has an intermediate focus 71. By means of the beam shaping device 12, at least a portion of the sample beam 70 is imaged onto the detector 40 to form an intensity distribution 79 on the detector 40. The beam shaping device 12 may include an optical lens for this purpose, as indicated by a typical lens shape in the figure. The intensity distribution 79 has at least one specific geometric property, for example a diameter of a beam spot and/or a distance between two beam spots in the intensity distribution 79. The detector 40 includes a radiation-sensitive sensor having a two-dimensional resolution which converts the intensity distribution 79 into an electrical signal 64. The evaluation device 80 includes an input unit 84 for the detector signal 64, a memory unit 81, a calculation unit 86, and an input unit 83 for a cutting gas signal 63. The cutting gas signal 63 may have at least two different states or values representing two different pressures of a cutting gas in a cutting gas device. The calculation unit 86 is configured to access the data of the input unit 84 for the detector signal 64, the data of the memory unit 81, and the data of the input unit 83 for the cutting gas signal 63. By means of the calculation unit 86, the evaluation device 80 determines a geometry parameter from the intensity distribution 79, which represents the specific geometric property of the intensity distribution. The geometry parameter can thus be, for example, the diameter of a beam spot or the distance between two beam spots in the intensity distribution 79. By means of the calculation unit 86, the evaluation device 80 further determines a correction value taking into consideration the cutting gas signal 63. Finally, the calculation unit 86 determines the axial position of a beam focus taking into consideration the geometry parameter and the correction value. The beam focus can be the intermediate focus 71 of the sample beam 70 or an energy beam focus of processing optics, the focal position of which is coupled to the position of the intermediate focus 71. For this purpose, the sample beam 70 can be generated in the processing optics by partial reflection from an energy beam or laser beam and decoupled from the processing optics. In the figure, an axially displaced sample beam 70′with a correspondingly displaced intermediate focus 71′is also sketched with dashed lines. If the axial position of the intermediate focus 71 is changed, the intensity distribution on the detector 40 and thus also the size of the geometry parameter changes as a result of the imaging by means of the beam shaping device 12.

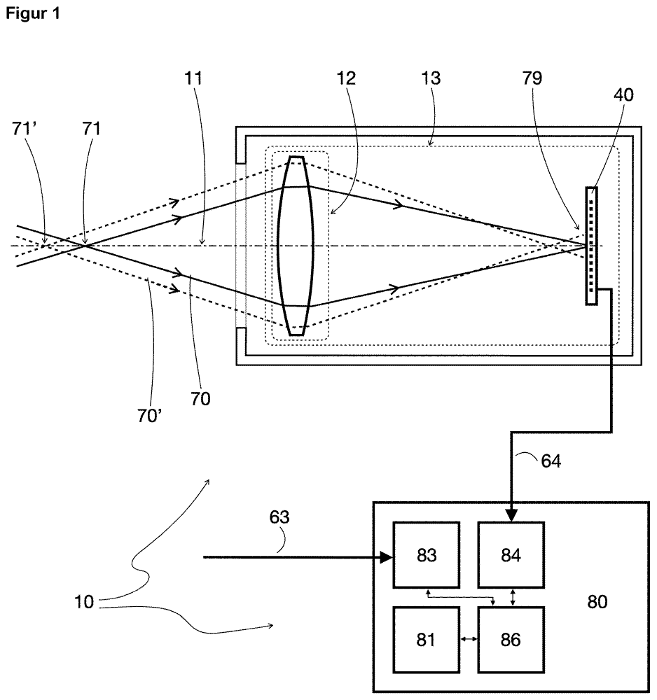

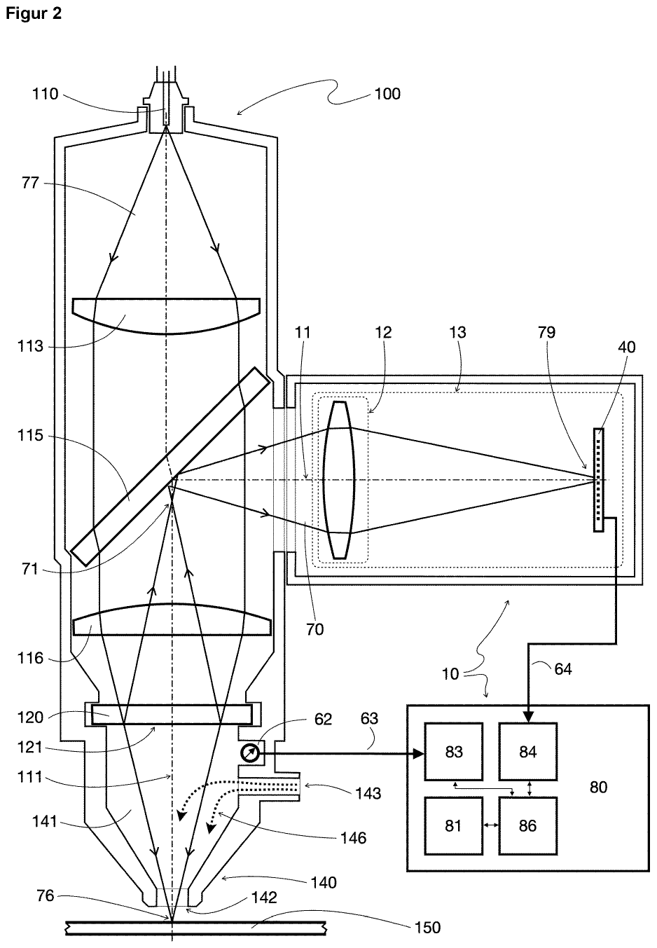

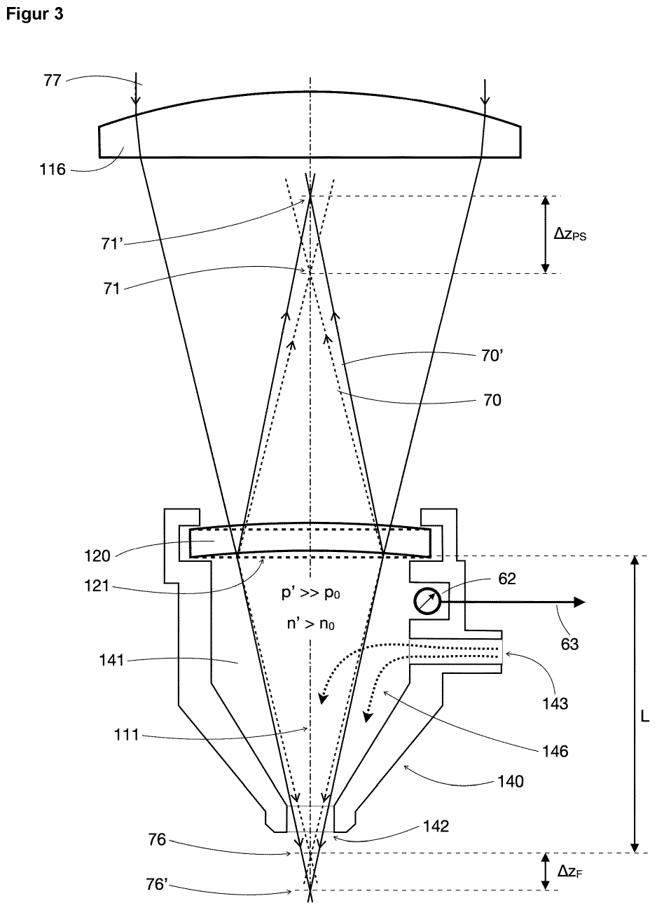

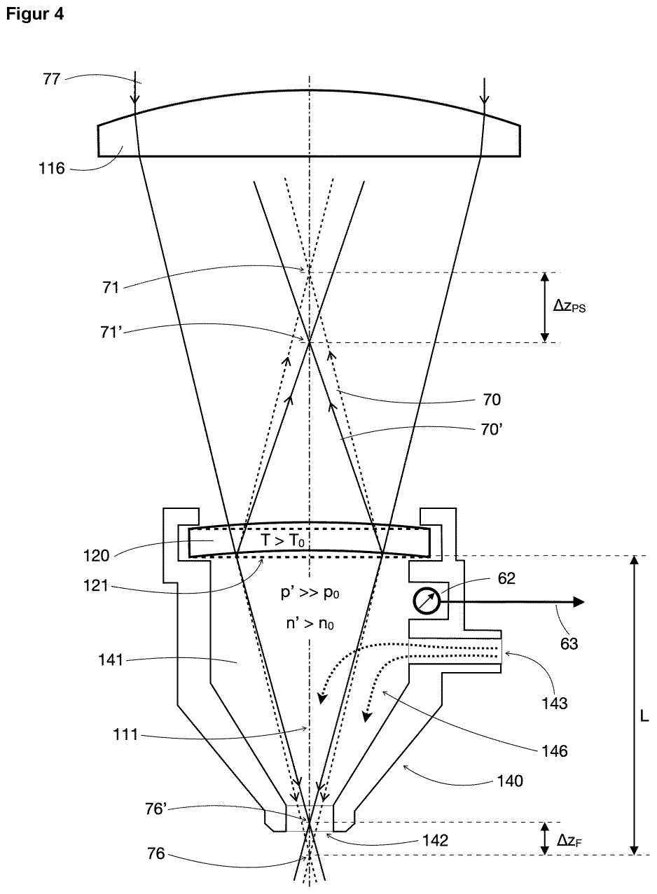

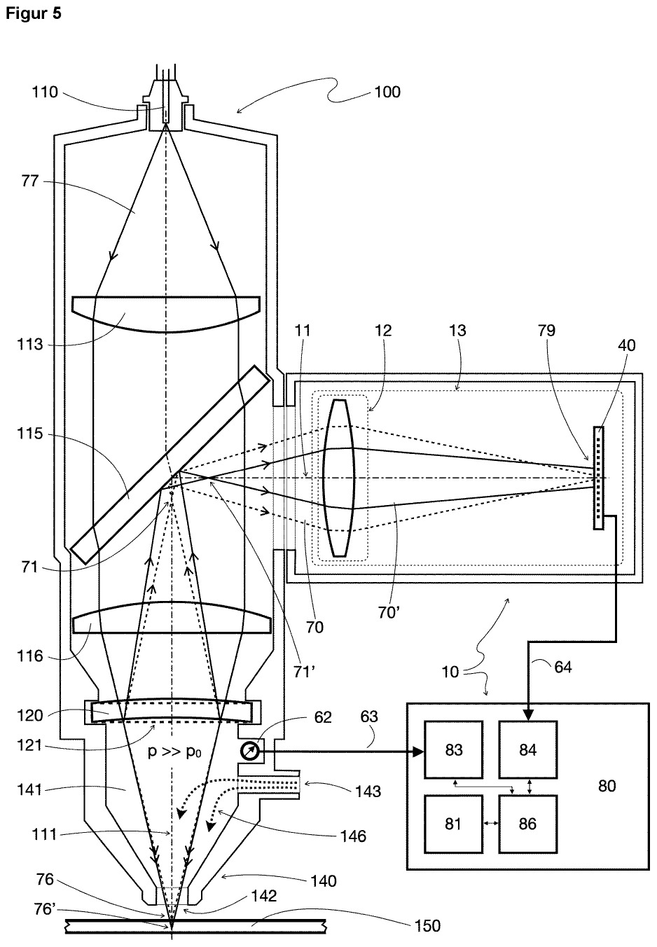

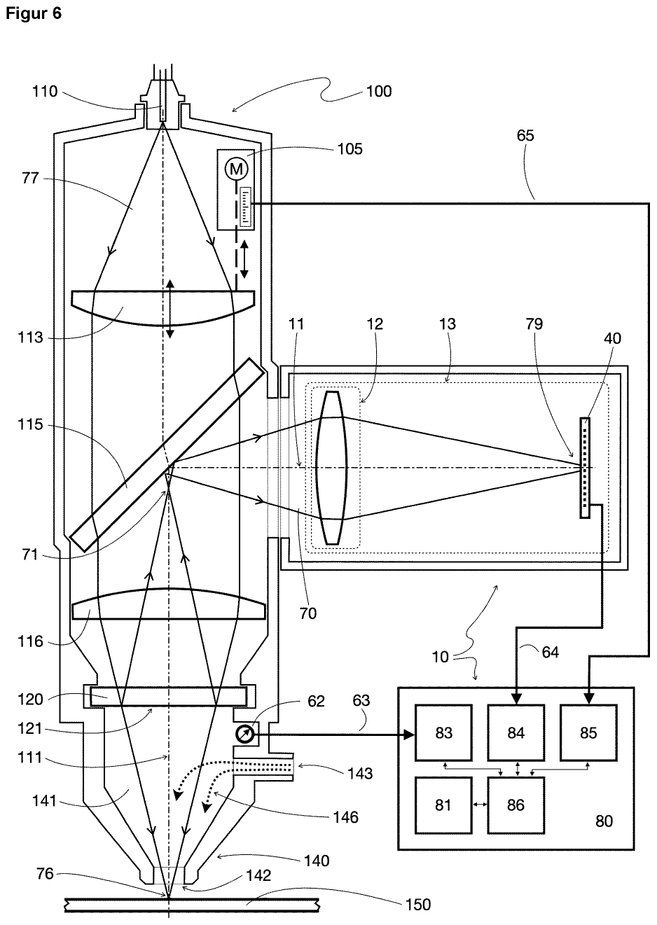

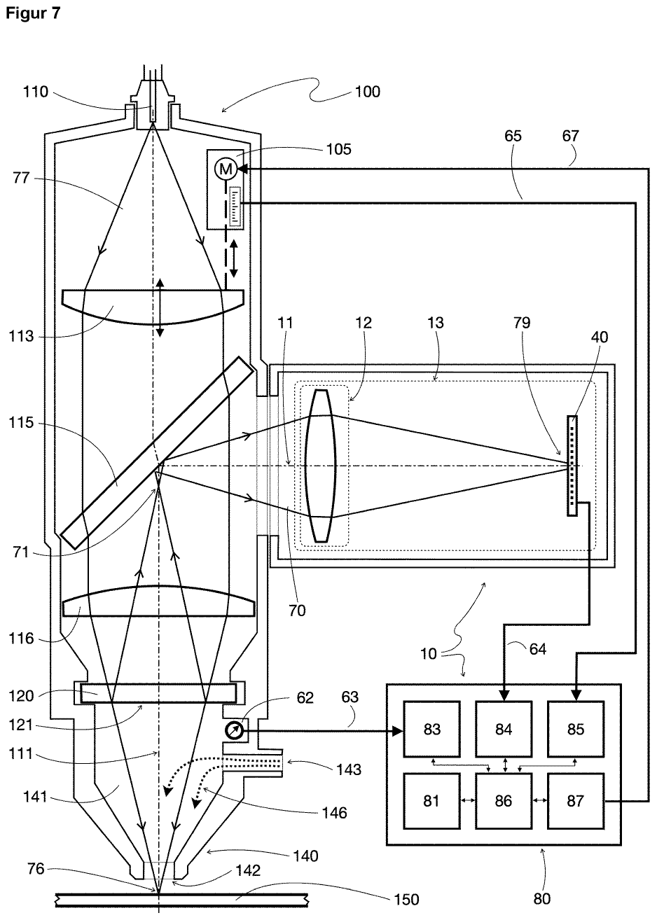

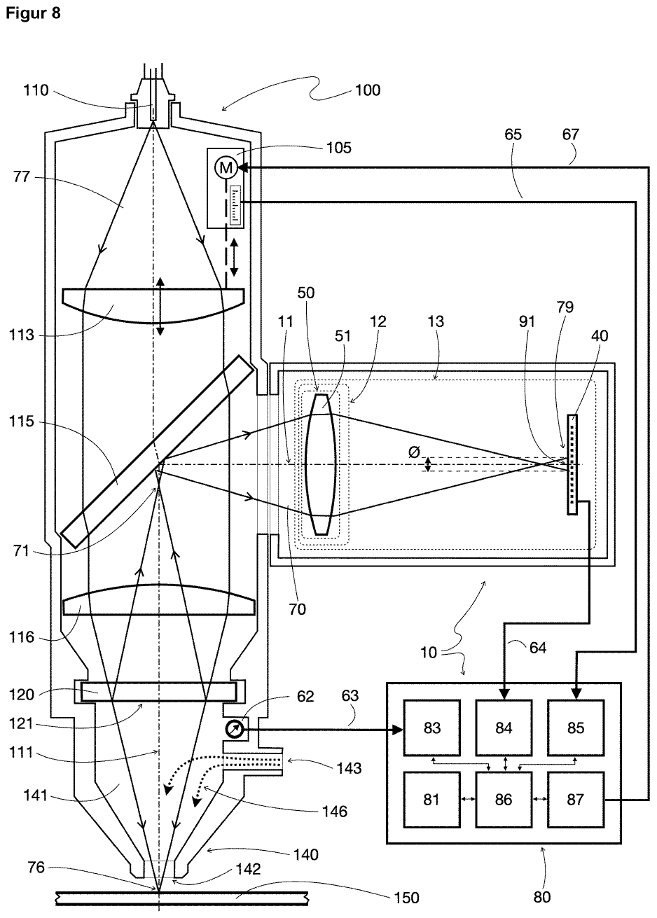

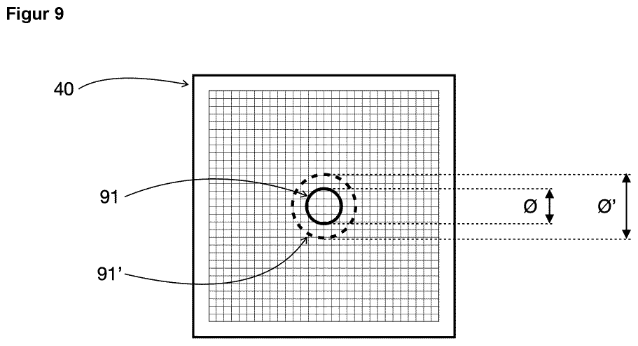

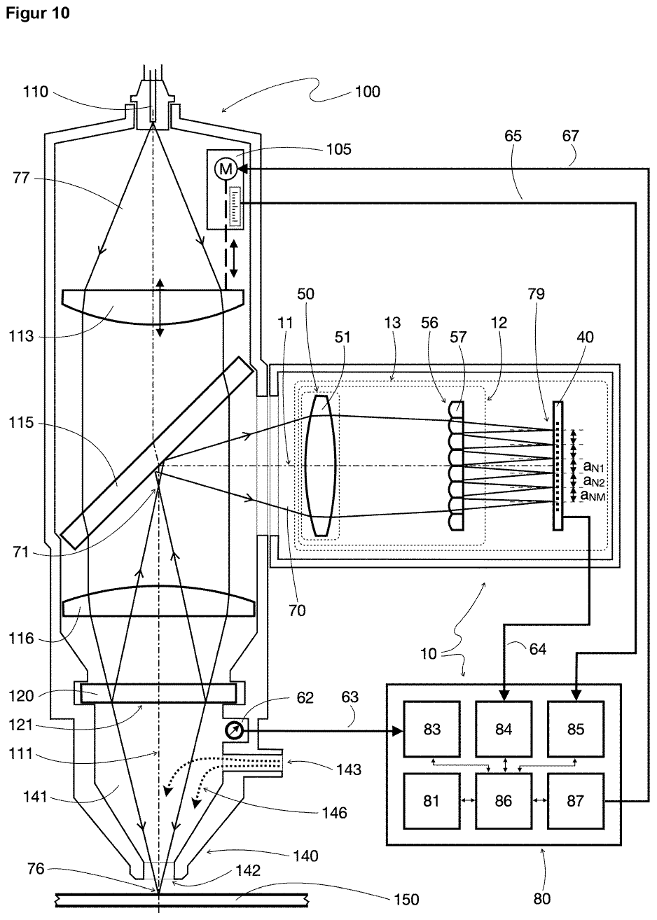

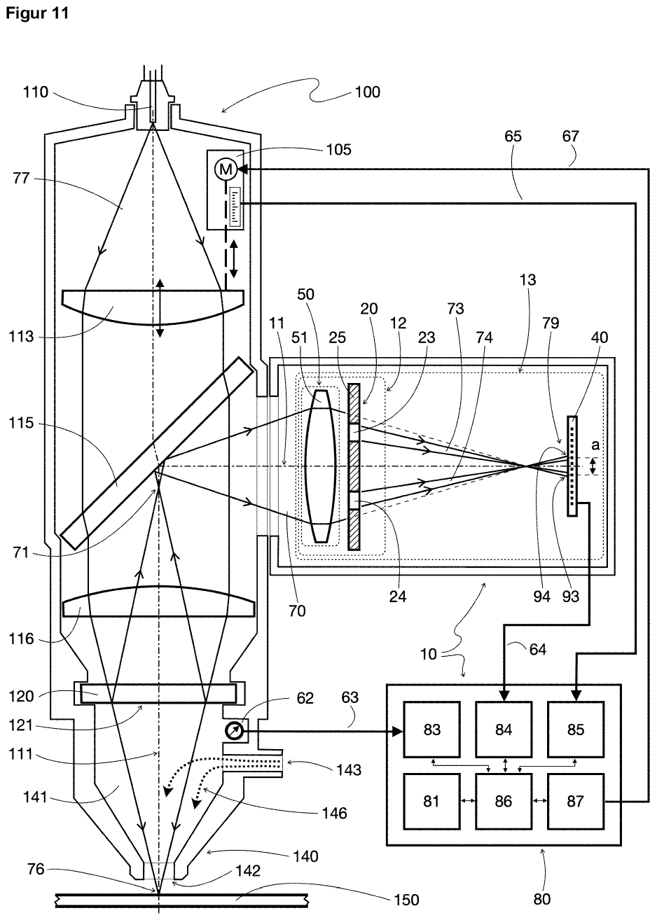

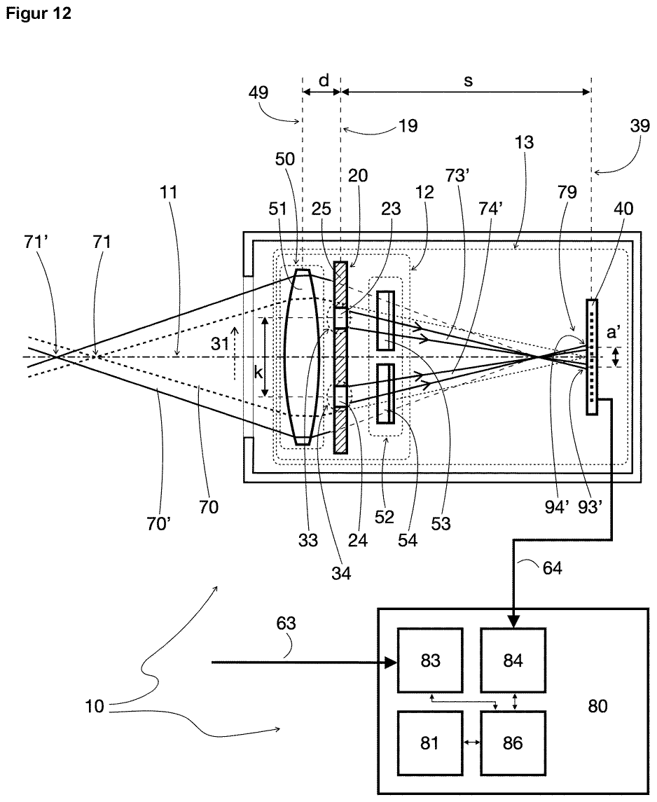

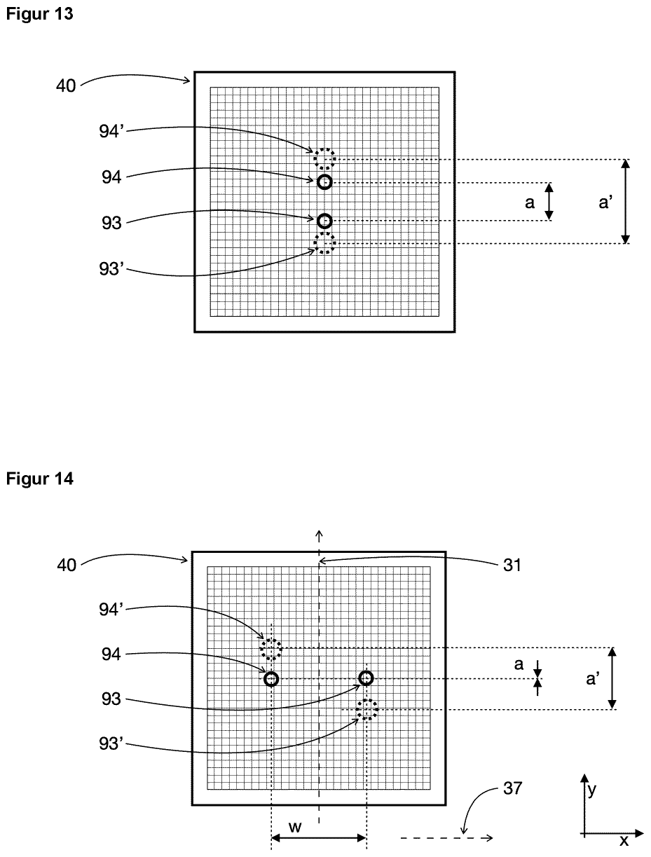

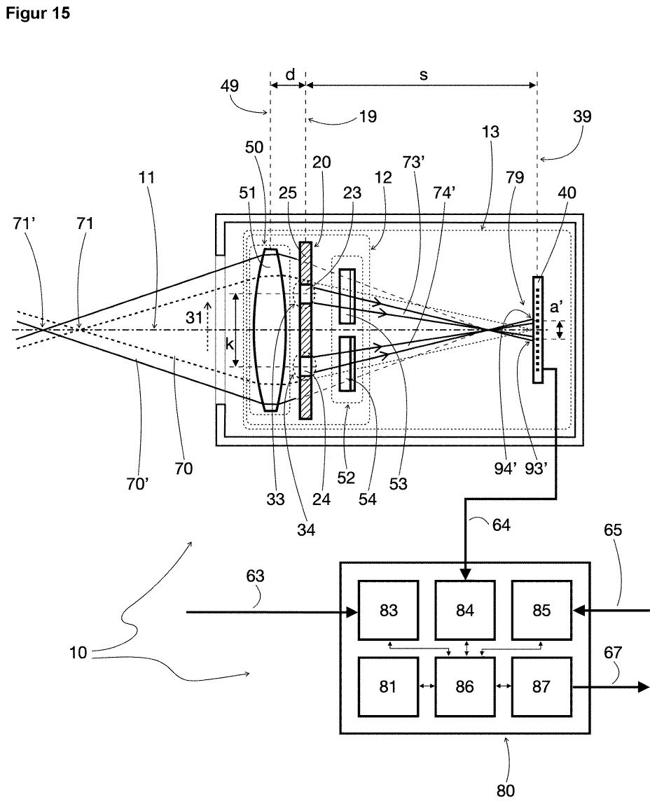

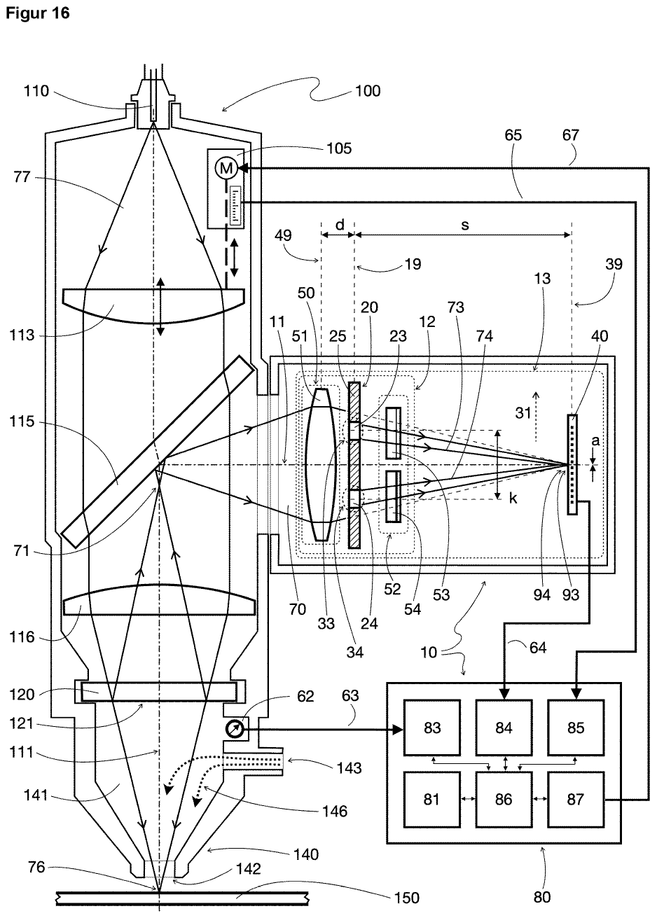

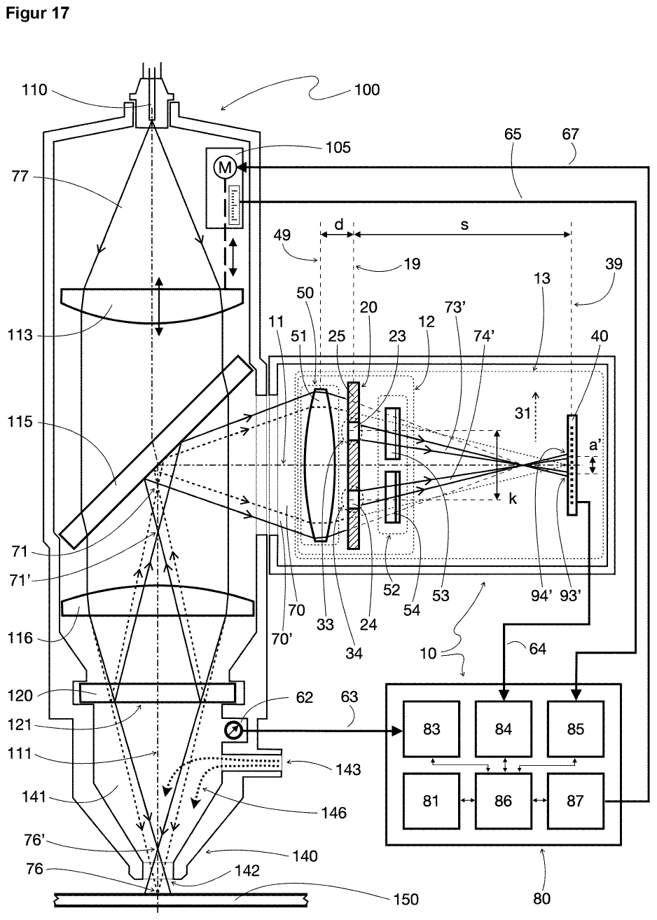

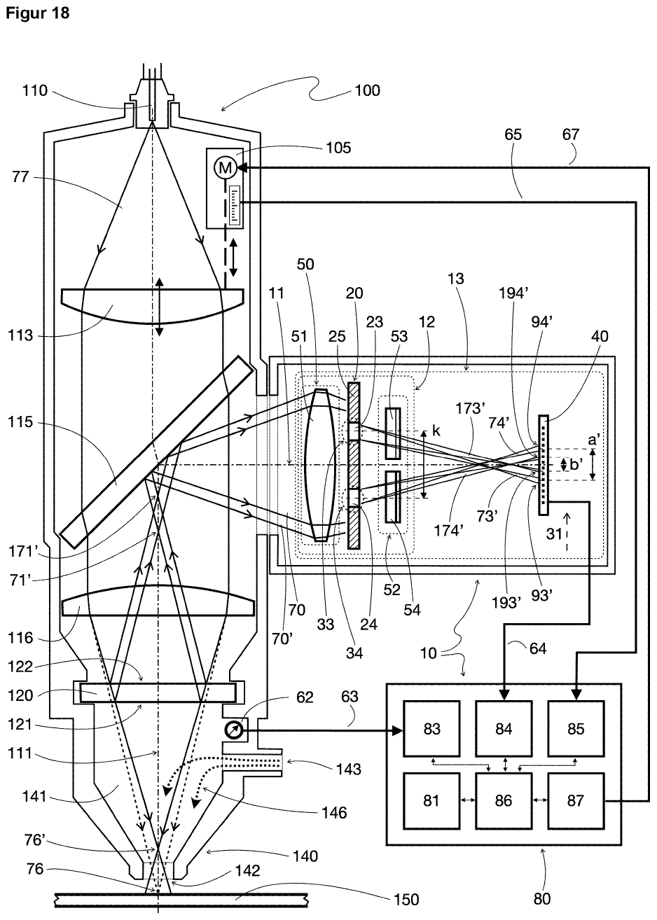

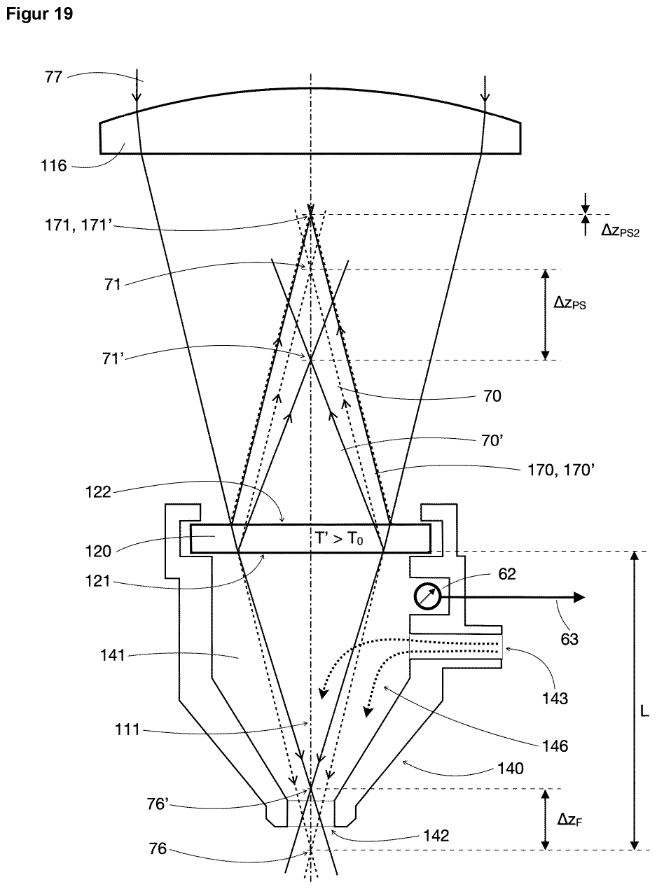

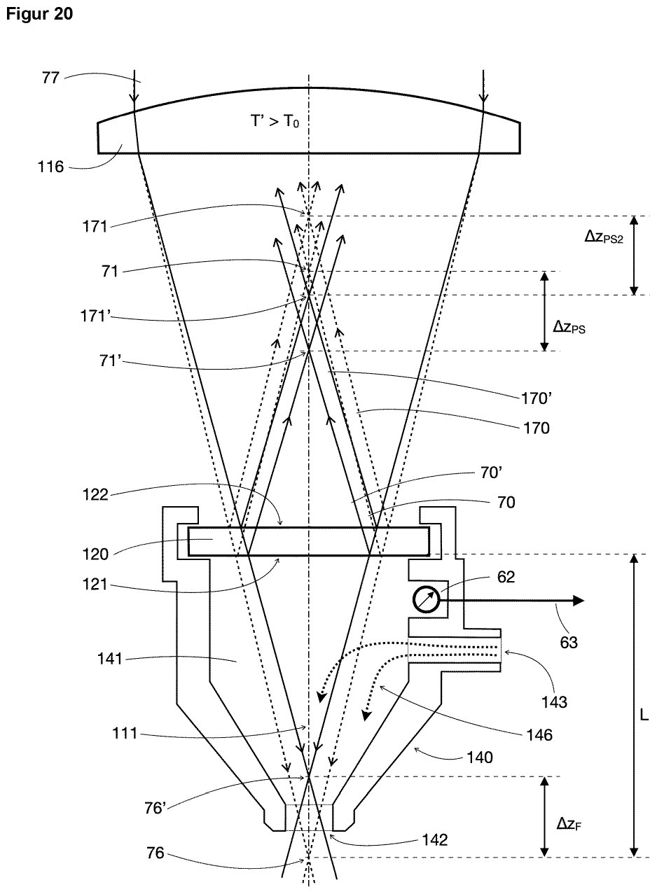

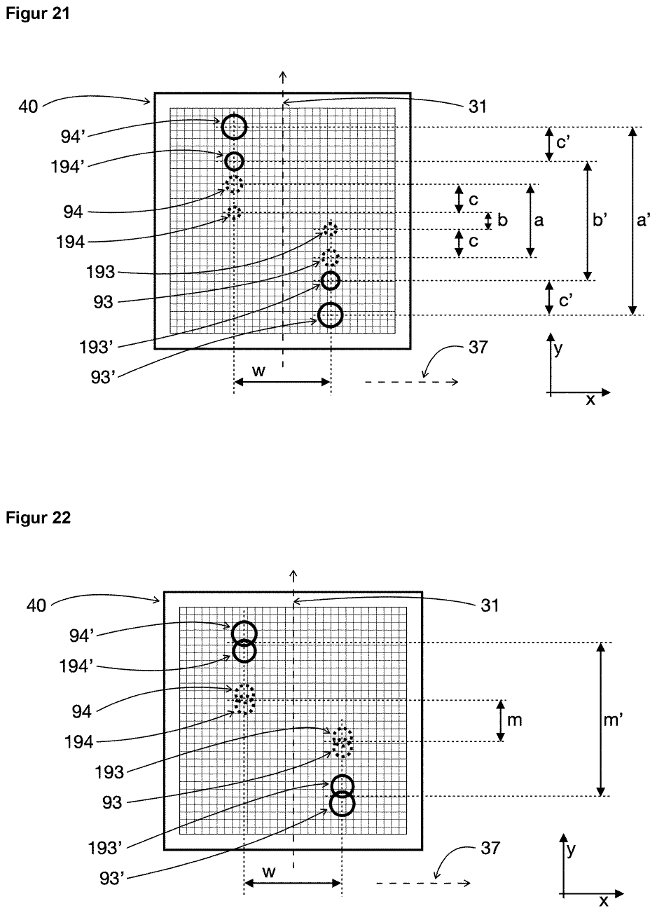

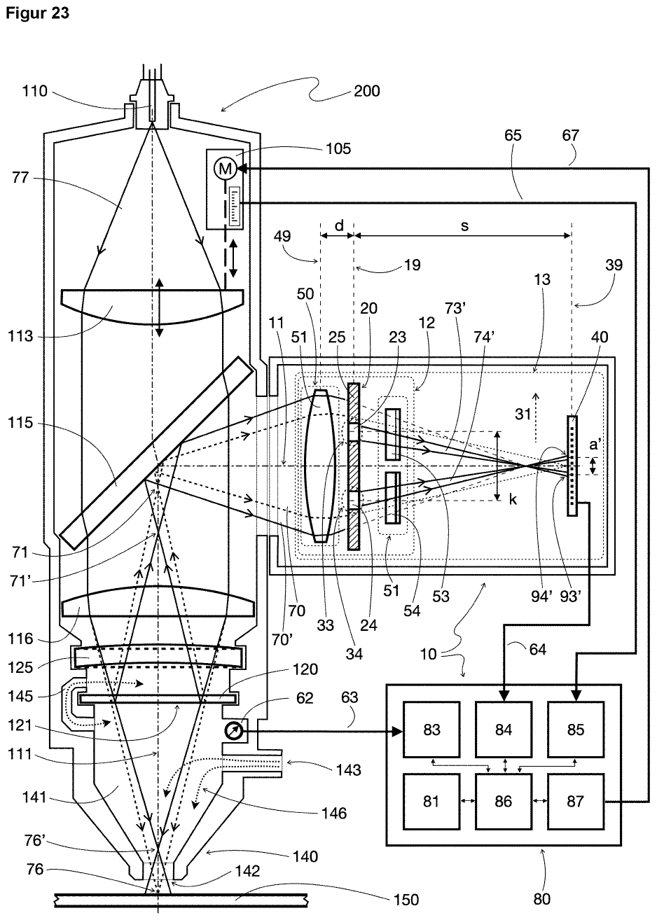

FIG. 2 shows the same beam analysis device 10 already shown in FIG. 1 and described above. The same reference signs refer to the same elements and features as in FIG. 1, so that reference is made to the associated description. For a better understanding of how the invention works, FIG. 2 shows the use of the beam analysis device 10 in conjunction with processing optics 100. The optical system of the processing optics 100 includes a collimator optic 113, a beam decoupler 115, a focusing optic 116 and a protective glass 120, which are arranged along an optical axis 111. An energy beam, particularly a laser beam 77, is fed to the processing optics 100 via an optical fiber.

The laser beam 77 is emitted from the optical fiber end 110 of the optical cable and collimated by the collimator optics 113. The collimated laser beam 77 passes through the beam decoupler 115 and is then focused into an energy beam focus 76 by the focusing optics 116. A workpiece 150 can be processed, in particular cut, with the energy beam focus 76. The protective glass 120 is arranged between the focusing optics 116 and the energy beam focus 76. The processing optics 100 shown is in particular a cutting optics. The processing optics 100 therefore has a cutting gas device 140. By means of the cutting gas device 140, a process gas or cutting gas 146 is supplied to the cutting process, which serves, among other things, to blow the melt out of the cutting gap. For this purpose, the cutting gas device 140 has a cavity 141 that extends from the protective glass 120 to a cutting nozzle 142. The cutting gas 146 is supplied to the cavity 141 via a cutting gas supply 143 and leaves the cavity 141 through the bore of the cutting nozzle 142 coaxially to the focused laser beam 77. At one boundary surface 121 of the protective glass 120, in particular at the outer boundary surface 121 which faces the workpiece 150 and which is adjacent to the cavity 141 of the cutting gas device 140, a fraction of the laser beam 77 is reflected back coaxially into the processing optics 100. The portion of the laser beam 77 that is reflected back forms the sample beam 70. The residual reflection of an anti-reflective coating located on the boundary surface 121 can be utilized to generate the sample beam 70. The sample beam 70 is therefore a mirror image of the energy beam 77 with greatly reduced power and therefore has the mirror-image geometric properties of the energy beam 77. The sample beam 70 has an intermediate focus 71, which is therefore a mirror image of the energy beam focus 76. This means that changes in the axial focus position 76 result in a proportional change in the mirrored focus or intermediate focus 71 in the sample beam 70. The sample beam 70 is decoupled from the processing optics 100 by means of the beam decoupler 115 and leaves the processing optics at a beam output. The housing of the beam analysis device 10 is coupled to the focal position sensor 13 at this beam output. The beam decoupler 115 may, for example, comprise an inclined partially reflective element. The partially reflective element of the beam decoupler 115 can be an anti-reflective-coated transparent plane-parallel plate. By means of the focal position sensor 13, the focal position in the sample beam 70 is determined, i.e. the focal position of the intermediate focus 71, and the position of the energy beam focus 76 of the laser beam 77 coupled thereto is determined from this. In this embodiment, the cutting gas device 140 has a gas pressure sensor 62, which can be arranged, for example, in a niche of the cavity 141 of the cutting gas device 140. The gas pressure sensor 62 measures the pressure in the cavity 140 and supplies the result of the pressure measurement as a cutting gas signal 63 to the evaluation device 80. For this purpose, the gas pressure sensor 62 can be connected directly to the input unit 83 of the evaluation device 80 via a data connection. It is also possible that the gas pressure sensor 62 is connected to a higher-level control system, for example a machine control system, and provides the pressure measurement result to the higher-level control system. In this case, the input unit 83 of the evaluation device 80 is then connected to the higher-level control system via a data link and receives the cutting gas signal 63 from there.

FIG. 3 schematically shows the beam path after the focusing optics 116 of the processing optics 100. In particular, the effects of a pressurized cutting gas 146 on the beam path of the energy beam 77 and on the beam path of the sample beam 70 are shown. For a detailed description of the cutting gas device 140, reference is made to the description in FIG. 2. The cutting gas 146 is supplied to the cavity 141 via a cutting gas supply 143 and leaves the cavity 141 through the bore of the cutting nozzle 142 coaxially to the focused laser beam 77. The cutting gas 146 is under a high pressure p′ and therefore has an increased refractive index n′. By increasing the refractive index n within the cavity 141, the laser beam 77 is refracted, i.e. the optical path within the cavity 141 changes, as a result of which its axial focus position 76 is shifted. The distance between the protective glass 120 and the target focus position 76 is marked as distance L. This also corresponds approximately to the length of the beam path through which the laser beam passes in the pressurized cavity 141. Since the refractive index of the pressurized cutting gas is greater than at normal pressure, the displaced energy beam focus 76′ is further away from the focusing optics 116. The energy beam focus 76 is displaced by an axial amount Δz_{F}. If the protective glass were completely rigid, the position of the intermediate focus 71 in the sample beam would not change. In reality, however, every material has an elasticity, albeit a small one. For this reason, the protective glass 120, which is under pressure from the cutting gas 146, suffers a slight deflection, so that the boundary surface 121 has a very slight curvature. This also shifts the intermediate focus 71 of the sample beam 70 towards a shifted sample beam 70′ with a shifted intermediate focus 71′. The intermediate focus 71 is thus shifted by an axial amount Δz_{PS}. The displacement amount Δz_{PS} of the intermediate focus 71 generally has a different magnitude than the displacement amount Δz_{F} of the energy beam focus 76. Both displacement amounts Δz_{F} and Δz_{PS} are approximately proportional to the level of the cutting gas pressure p. By the evaluation device 80 of the beam analysis device 10 taking into consideration the cutting gas signal 63, the deviation between the two displacement amounts Δz_{F} and Δz_{PS} can be compensated for and in this way the actual position of the energy beam focus 76 can be determined more precisely.

Like FIG. 3, FIG. 4 shows the beam path after the focusing optics 116 of the processing optics 100. In contrast to the illustration in FIG. 3, FIG. 4 shows a situation in which a cutting gas 146 is supplied under high pressure and, in addition, the temperature T of the protective glass 120 is increased compared to the ambient temperature T₀ as a result of a low absorption of the energy beam 77 in the protective glass 120, whereby a thermal focus shift occurs in the protective glass 120. The thermal focus shift acts like a weak additional refracting force, so that the shifted energy beam focus 76′ has moved closer to the focusing optics 116 in this example. The distance between the intermediate focus 71 and the protective glass is also shortened as a result. However, the sample beam 70 passes through the protective glass 120 a second time after reflection at the boundary surface 121, so that the effect of the thermal lens in the protective glass 120 on the sample beam 70 is approximately twice as great as the effect on the energy beam 77. This means that the displacement amount Δz_{PS} of the intermediate focus 71 is greater in this case than the displacement amount Δz_{F} of the energy beam focus 76.

FIG. 5 shows a beam analysis device 10 as in FIG. 1 in conjunction with processing optics 100 as in FIG. 2. FIG. 5 shows schematically how the beam pattern of laser beam 77 and sample beam 70 change when the cutting gas 146 is supplied under high pressure p. In particular, this results in a different intensity distribution 79 on the detector 40 of the focal position sensor 13. In the beam analysis device 10 shown in FIG. 6, the evaluation device 80 additionally has an input unit 85 for a lens position signal 65. Apart from that, the beam analysis device 10 corresponds to the device shown in FIGS. 1, 2 and 5. Reference is made to the corresponding descriptions. In this example, the processing optics 100 includes a collimator optics or collimator lens 113 that can be axially adjusted by means of a positioning device 105 for the targeted adjustment of the position of the energy beam focus 76. Since the imaging properties of the entire optical system of the processing optics 100 can change slightly with the position of the collimator, the accuracy of the determined focal position is improved by taking into consideration the lens position signal 65 when determining the focal position by the evaluation device 80.

The beam analysis device 10 shown in FIG. 7 additionally has an output unit 87 for a focus tracking signal 67. Apart from that, the beam analysis device 10 corresponds to the device shown in FIG. 6.

In this embodiment, the evaluation device 80 is configured to calculate a focus tracking signal 67 from the determined axial position of the focus 76 of the energy beam 77 as the actual focus position and from a predefined target focus position. The target focus position can also be a previously determined focal position or a focal position determined under optimum conditions.

The focus tracking signal 67 is transferred directly or alternatively via a higher-level control device, for example a machine controller, to the positioning device 105, by means of which the position of an axially positionable lens of the laser processing optics 100, in this case the collimator optics 113, can be adjusted. In this way, a particularly precise control of the focus position of the energy beam focus 76 is realized by means of the improved accuracy of the determination of the focal position.

FIG. 8 shows a beam analysis device 10 similar to the device described in FIG. 7 with a first embodiment of the focal position sensor 13. In the first embodiment of the focal position sensor 13, the beam shaping device 12 includes an imaging device 50 with an optical lens 51. As a result of imaging with the lens 51, the intensity distribution 79 on the detector has a beam spot 91, the diameter Ø of which is determined as a geometry parameter by the evaluation device 80. FIG. 9 schematically shows the intensity distribution 79 on the detector 40 with a beam spot 91 for the beam analysis device 10 according to FIG. 8 with the first embodiment of the focal position sensor 13. The beam spot 91 has a diameter Ø. If the axial focal position of the energy beam focus 76 is changed, the changed beam spot 91′ has a changed diameter Ø′, in this example an increased diameter.

FIG. 10 shows a beam analysis device 10 with a second example of the focal position sensor 13.

The use of the beam analysis device 10 on a typical processing optics 100 is also shown here, the structure of which corresponds to the processing optics 100 shown in FIG. 7. For the description of the processing optics 100, reference is therefore made to the descriptions in FIGS. 2 and 7. In this second embodiment example, the focal position sensor 13 includes a lens array 56 with a plurality of individual lens elements 57 arranged side by side in a plane. The beam shaping device 12 can optionally include an imaging device 50 with an optical lens 51. Each individual lens element 57 illuminated by the sample beam 70 images a small aperture section of the sample beam 70 onto the detector 40. Consequently, an intensity distribution 79 with a plurality of individual beam spots is generated on the detector 40, which have distances a_{N1} . . . a_{NM} from one another. The distances a_{N1} . . . a_{NM} of the beam spots vary as a function of the axial position of the intermediate focus 71 and thus with the axial position of the energy beam focus 76. In this example, the evaluation device 80 uses one or more of the distances a_{N1} . . . a_{NM} of the beam spots as geometry parameters for determining the axial focal position.

FIG. 11 shows a further embodiment of the beam analysis device 10 in conjunction with a typical processing optics 100 already known from FIG. 7, 8 or 10. The beam analysis device 10 shown here is equipped with a third embodiment of the focal position sensor 13. In the third embodiment of the focal position sensor 13, the beam shaping device 12 comprises an imaging device 50 with an optical lens 51 and a modulation device 20 with a blocking zone 25 and two transmission zones 23, 24. Two partial beams 73, 74 are extracted from the sample beam 70 by means of the modulation device 20. For this purpose, the modulation device 20 has the two transmission zones 23, 24. By means of the imaging device 50, the partial beams 73, 74 extracted from the sample beam 70 are imaged onto the detector 40 to form an intensity distribution 79 with two beam spots 93, 94. The partial beam 73 detached from the transmission zone 23 forms the beam spot 93 on the detector 40.

Correspondingly, the beam spot 94 on the detector 40 is formed by the partial beam 74, which is extracted from the transmission zone 24. The distance a between the beam spots 93, 94 is dependent on the axial position of the intermediate focus 71 of the sample beam 70 and thus on the axial position of the energy beam focus 76 of the laser beam 77. Consequently, the axial position of the beam focus 71 and thus the axial position of the energy beam focus 76 can be determined from the size of the distance a. In the third embodiment of the focal position sensor 13, the evaluation device 80 therefore determines the distance a between the beam spots 93, 94 from the intensity distribution 79 as the geometry parameter, from which the focal position 76 is then determined taking into consideration the cutting gas signal 63.

FIG. 12 shows the beam analysis device 10 according to the invention with a fourth embodiment of the focal position sensor 13. The fourth embodiment of the focal position sensor 13 contains all the elements of the third embodiment of the focal position sensor 13 shown in FIG. 11 and additionally a beam separator device 52. In the fourth embodiment, the beam shaping device 12 of the beam analysis device 10 thus comprises an imaging device 50 with an optical lens 51, a modulation device 20, and a beam separator device 52. The beam separator device 52 comprises at least one partial beam deflector element 53, 54. In the embodiment example shown here, the beam separator device 52 contains two partial beam deflector elements 53, 54. The modulation device 20 serves to extract two partial beams 73, 74 from the sample beam 70 in a plane of the partial beam extraction 19. For this purpose, the modulation device 20 has at least two mutually delimited transmission zones 23, 24 and at least one blocking zone 25, which completely encloses the transmission zones 23, 24 in each case and separates them from one another. In the area of the transmission zones 23, 24, the radiation propagates further to the detector 40; in the area of the blocking zone 25, the propagation of the radiation to the detector is obstructed. In this way, the edges of the transmission zones 23, 24 delimit two partial apertures 33, 34, which define the cross-sections of the partial beams 73, 74 formed in this way in the plane of the partial beam extraction 19. The centers of the partial apertures 33, 34 are at a distance k from one another. The distance k, i.e. the imaginary shortest connection of the centers of the partial apertures 33, 34, defines a first lateral direction 31. The first lateral direction 31 is aligned perpendicularly to the local optical axis 11. In the representation of FIG. 12, the first lateral direction 31 is aligned in the drawing plane, for example parallel to a y-coordinate axis, with the local optical axis 11 being associated with a z-coordinate axis. The modulation device 20 modulates the intensity distribution of the sample beam 70, thereby forming a shaped sample beam with the two partial beams 73, 74. The modulation device 20 may, for example, be a double aperture diaphragm with two openings, the two openings representing the transmission zones 23, 24. By means of the imaging device 50, the partial beams 73, 74 of the shaped sample beam are imaged onto the detector 40. In a sensor plane 39, the detector 40 has a sensor that is sensitive to light radiation and has a two-dimensional spatial resolution, which converts the intensity distribution 79 on the detector 40 into electrical signals. The detector signal 64 thus formed is fed to the evaluation device 80 via the input unit 84 and processed by the evaluation device 80, in particular by the calculation unit 86 of the evaluation unit 80. By imaging the shaped sample beam onto the detector 40 by means of the imaging device 50, a beam spot 93, 94 is formed in the intensity distribution 79 on the detector 40 for each of the partial beams 73, 74 of the shaped sample beam. The two beam spots 93, 94 have a distance a from one another on the detector 40 in the first lateral direction 31. The distance a depends, among other things, on the distance k of the partial apertures 33, 34, on the distance s between the plane of the partial beam extraction 19 and the sensor plane 39, and on the axial position of the intermediate focus 71. Thus, the axial position of the intermediate focus 71 can be determined from the distance a and thus the axial position of the energy beam focus 76 of the processing optics 100, which is not shown in FIG. 12. So that the evaluation device 80 can clearly assign the beam spots 93, 94 and can thus distinguish between a positive and a negative displacement of the intermediate focus 71, i.e. to the front or to the rear, at least one of the partial beams 73, 74 is deflected or displaced in a second lateral direction 37, which is aligned transversely to the first lateral direction 31. The second lateral direction 37 can, for example, be aligned perpendicularly to the first lateral direction 31. Like the first lateral direction 31, the second lateral direction 37 is aligned perpendicularly to the local optical axis 11. In the embodiment of FIG. 12, for example, the second lateral direction 37 is aligned perpendicularly to the drawing plane and can therefore not be shown in FIG. 12. In the embodiment of FIG. 12, both partial beams 73, 74 are deflected along the second lateral direction 37. For this purpose, the beam shaping device 12 has the beam separator device 52, which in this example comprises two wedge plates as partial beam deflector elements 53, 54. In each case, one of the wedge plates 53, 54 is aligned in the beam direction behind one of the transmission zones 23, 24. In the example shown, both partial beams are thus deflected by approximately the same amount, but in opposite directions, along the second lateral direction 37, i.e. out of the drawing plane. The deflection direction is defined by the orientation of the wedge angle of the wedge plates.

For example, the partial beam 73 can be deflected by an angular amount in the range from 0.02° to 6° by means of the wedge plate 53, and the partial beam 74 can be deflected by the same angular amount in the opposite direction by means of the wedge plate 54. As a result of the deflection and the propagation to the detector 40, the beam spots 93, 94 have a distance w between them in the direction of the second lateral direction 37. The distance w between the beam spots 93, 94 cannot be shown in FIG. 12 since the distance w is perpendicular to the drawing plane. To illustrate this deflection, which occurs out of the drawing plane in FIG. 12, see FIG. 14, explained further below, in which the intensity distribution 79 on the detector 40 with the two beam spots 93, 94 is shown. In this fourth embodiment example for the focal position sensor 13, the distance a in the first lateral direction is the geometry parameter from which the axial focus position of the sample beam 70 and thus the focus position of the energy beam of the processing optics is determined in the evaluation device 80. For this purpose, the evaluation unit 80 comprises at least the input unit 84 for the detector signal 64, the memory unit 81, e.g. for storing calibration data, the calculation unit 86, and the input unit 83 for the cutting gas signal 63. The determination of the axial position of the focus by the calculation unit 86 takes place taking into consideration the geometry parameter and a correction value, which is determined taking into consideration the cutting gas signal 63, wherein the cutting gas signal 63 represents the level of the pressure of a cutting gas. To better illustrate the mode of operation, FIG. 12 shows both a sample beam 70 with an intermediate focus 71 with dashed lines and an axially displaced sample beam 70′ with a displaced intermediate focus 71′ and the correspondingly modified partial beams 73′ and 74′ with solid lines. The shifted beam spots 93′, 94′ with the changed spacing a′ in the first lateral direction 31 arise from the shifted sample beam 70′.

FIG. 13 shows a schematic, exemplary representation of an intensity distribution on the detector 40 for a beam analysis device 10 with a focal position sensor 13 according to the third embodiment of the focal position sensor, i.e. for a beam analysis device 10 as shown in FIG. 11. The intensity distribution on the detector 40 is composed of the beam spots 93, 94, which can be focused or approximately focused due to the imaging by means of the imaging device 50. The beam spots 93, 94 have a distance a between them. The distance a changes when the axial position of the intermediate focus 71 is changed. FIG. 13 also shows beam spots 93′ and 94′, which correspond to an exemplary changed axial focus position. In the changed focus position, the changed beam spots 93′, 94′ have a distance a′ from each other, which in this example is greater than the distance a at the original focus position. It can be seen that the positions of the beam spots 93, 94 or 93′, 94′ vary along a direction that lies on the same imaginary line for both beam spots 93, 94. If the distance a is zero, the beam spots 93, 94 would therefore lie on top of each other. If the distance a is negative, the beam spots 93, 94 would swap their relative position to each other. The evaluation device 80 can therefore not reliably identify which beam spot is generated by which partial beam or from which transmission zone. Due to this uncertainty, a focal position sensor 13 according to the third embodiment example can only be used with a limited detection range for the axial focal position.

FIG. 14 shows a schematic, exemplary representation of an intensity distribution on the detector 40 for a beam analysis device 10 with a focal position sensor 13 according to the fourth embodiment of the focal position sensor, i.e. for a beam analysis device 10 as shown in FIG. 12. The intensity distribution on the detector 40 is composed of the beam spots 93, 94, which are generated by the partial beams 73, 74 extracted from the sample beam 70 by means of the modulation device 20. The beam spots 93, 94 have the distance a from one another in the first lateral direction 31. The distance a is zero in the exemplary distribution of the beam spots shown but can have any value. The distance a changes when the axial position of the intermediate focus 71 changes. Due to the deflection of the partial beams 73, 74 by means of the beam separator device 52, the beam spots 93, 94 have the distance w from each other in the second lateral direction 37.

The distance w does not change when the axial position of the intermediate focus 71 is changed.

FIG. 14 also shows beam spots 93′ and 94′, which correspond to an exemplary changed axial focus position. In the changed focus position, the changed beam spots 93′, 94′ have a distance a′ from each other. It can be seen that the positions of the beam spots 93, 94 or 93′, 94′ vary along the same direction, namely along the first lateral direction 31, but each beam spot lies on its own imaginary line, the two imaginary lines in the second lateral direction 37 being offset parallel to one another by the amount w. Even at a distance a=0, the beam spots 93, 94 are therefore spatially separated from one another. The evaluation device 80 can therefore always reliably identify which beam spot is generated by which partial beam or is extracted from which transmission zone. A focal position sensor 13 according to the fourth embodiment example is therefore suitable for a significantly larger detection range for the axial focal position than a focal position sensor according to the third embodiment example. This advantage of the fourth embodiment of the focal position sensor 13 is achieved by means of the beam separator device 52.

FIG. 15 shows a further embodiment of the beam analysis device 10 according to the invention, in which the focal position sensor 13 is constructed in accordance with the fourth embodiment of the focal position sensor 13 already shown in FIG. 12. For an explanation of the elements and mode of operation of the focal position sensor, reference is therefore made to the description of FIG. 12. The embodiment of the beam analysis device 10 shown here differs from the embodiment in FIG. 12 by additional elements in the evaluation device 80. Thus, the evaluation device 80 of the beam analysis device 10 shown here additionally has an input unit 85 for a lens position signal 65. This input unit 85 is intended for use on processing optics which have an adjustable lens unit for adjusting the axial focal position. Such an adjustable lens unit can be, for example, an adjustable collimator 113, as shown in FIGS. 6-8 and 10 and 11. Since the imaging properties of the entire optical system of the processing optics 100 can change slightly with the position of an adjustable lens unit, taking the lens position signal 65 into consideration when determining the focal position by the evaluation device 80 improves the accuracy of the determined focal position. Furthermore, the evaluation device 80 of the beam analysis device 10 shown here also has an output unit 87 for a focus tracking signal 67. In this embodiment, the evaluation device 80 is configured to calculate a focus tracking signal 67 from the determined axial position of the focus 76 of the energy beam 77 as the actual focus position, and from a predefined target focus position. The focus tracking signal 67 is intended for controlling an adjustable lens unit of processing optics, with which the axial focal position of the optics can be adjusted. Thus, the embodiment of the beam analysis device 10 shown here is suitable and intended for controlling the focal position of an energy beam focus of laser processing optics.

FIG. 16 shows the use of a beam analysis device 10 according to the embodiment shown and described in FIG. 15 with a focal position sensor 13 according to the fourth embodiment of the focal position sensor in conjunction with processing optics 100 with an adjustable collimator 113.

For the description of the processing optics 100, reference is made to the descriptions in particular of FIGS. 2 and 7. With the system shown here, consisting of beam analysis device 10 and processing optics 100, fast and precise control of the focal position during the processing process can be realized.

FIG. 17 shows the same system consisting of beam analysis device 10 and processing optics 100 as in FIG. 16. FIG. 17 shows a modified beam path compared to FIG. 16. In FIG. 17, the position of the energy beam focus 76′ is shifted upwards towards the optics compared to the original position 76 of the energy beam focus, which is shown here with a dashed beam path for better comparison. This is a typical situation that can occur as a result of a thermal focus shift during the processing process in the processing optics 100. The sample beam 70′ generated by reflection at the lower protective glass boundary surface 121 has an intermediate focus 71′, the position of which is also shifted relative to the original position 71 of the intermediate focus. As a result of the mirror image of the energy beam focus 76′, the intermediate focus 71′ is shifted downwards. The modified sample beam 70′ is decoupled from the processing optics 100 and irradiated into the beam analysis device 10. Modified partial beams 73′, 74′ are extracted from the modified sample beam 70′ by means of the modulation device 20 and imaged onto the detector 40 by means of the imaging device 50. In the intensity distribution on the detector, the resulting beam spots 93′, 94′ have a modified distance a′ from one another in the first lateral direction 31. This changed distance a′ is determined as a geometry parameter by the evaluation device 80. The evaluation device 80 also determines a correction value using the current cutting gas signal 63 and determines the changed focus position 76′ using the distance a′ and the correction value. By comparison with the original or previously determined focal position 76, the evaluation device 80 can calculate a focus tracking signal 67 and transmit it to the positioning device 105 for the adjustable collimator 113. On the basis of the focus tracking signal 67, the collimator 113 can be adjusted by means of the positioning device 105 so that the changed focus position 76′ corresponds again to the original focus position 76 or to a target focus position 76.

FIG. 18 shows the same system consisting of beam analysis device 10 and processing optics 100 as FIGS. 16 and 17. As already explained in other examples above, a first sample beam 70 or a modified sample beam 70′ with an intermediate focus 71′ is generated by partial reflection of the laser beam 77 at the outer boundary surface 121 of the protective glass 120. FIG. 18 shows a situation in which, in addition, a second sample beam 170 or a modified second sample beam 170′ with an intermediate focus 171′ is generated by partial reflection of the laser beam 77 at the inner, second boundary surface 122 of the protective glass 120. Like the first sample beam 70′, the second sample beam 170′ is decoupled and fed to the beam analysis device 10 with the focal position sensor 13. As shown here, a focal position sensor 13 according to the fourth embodiment, which is shown and explained in detail in FIGS. 12 and 15, is preferably used. Here, two partial beams 73′, 74′, 173′, 174′ are generated from each sample beam 70′, 170′ by means of the modulation device 20 of the beam shaping device 12. Each partial beam 73′, 74′, 173′, 174′ generates a beam spot 93′, 94′, 193′, 194′ on the detector 40. Therein, the beam spots 93′and 94′ formed by the imaging of the sample beam 70′ form a first beam spot pair, and the further beam spots 193′and 194′ formed by the imaging of the second sample beam 170′ form a second beam spot pair. The beam spots 93′, 94′ of the first beam spot pair have a distance a′ from one another in the first lateral direction 31, while the beam spots 193′, 194′ of the second beam spot pair have a distance b′ from each other in the first lateral direction 31. Both pairs of beam spots can be evaluated by the evaluation device 80 and the distances a and b or a′ and b′ can be determined. The evaluation device 80 is therefore configured to identify a corresponding number of beam spots in the intensity distribution 79 on the detector 40.

The advantage of evaluating the beam spots for both sample beams 70 and 170 is that with the first beam spot pair 93, 94, focal position information is obtained which contains a thermal shift of the protective glass, because the sample beam 70 has passed through the protective glass twice, and that with the second beam spot pair 193, 194, a focal position information is obtained which does not contain the thermal shift of the protective glass because the second sample beam 170 is generated by the second, inner boundary surface 122 of the protective glass 120 and therefore does not pass through the protective glass 120. In this way, the evaluation device 80 can distinguish a focus shift caused by the protective glass 120 from other focus shift components of the entire processing optics 100. In particular, this also makes it possible for the evaluation device 80 to determine the focus shift of the protective glass 120 separately and to provide a warning signal if the focus shift of the protective glass 120 has increased significantly, which usually indicates heavy contamination of the protective glass. This can be used to automatically indicate that the protective glass needs to be replaced.

FIGS. 19 and 20 show the generation of two sample beams 70. 170, as previously shown in FIG. 18, which are generated by partial reflection of the laser beam 77 on the one hand at the outer boundary surface 121 of the protective glass 120, and on the other hand at the second boundary surface 122 of the protective glass, in a somewhat more detailed partial representation of the lower region of the processing optics around the protective glass 120. FIG. 19 shows in particular the beam path for laser beam 77 when the protective glass 120 has a significantly increased temperature T′ due to absorption of laser radiation as a result of contamination and thus generates a thermal focus shift. The focused laser beam 77 is additionally refracted and more strongly focused by the thermally induced refractive power in the protective glass 120, as a result of which the energy beam focus 76′ is shifted upwards, i.e. towards the optics. The beam path without thermal focus shift and the original energy beam focus 76 are shown with dashed lines for comparison. The position of the energy beam focus is shifted by the amount Δz_{F}. The intermediate focus 71′ of the sample beam 70′ generated by reflection at the lower boundary surface 121 is also shifted, namely by the amount Δz_{PS}. This shift Δz_{PS} of the intermediate focus 71′ is approximately twice as large as the shift Δz_{F} of the energy beam focus 76′ because the sample beam 70′ has passed through the protective glass once before reflection and once after reflection, i.e. twice, and therefore the thermally induced refractive force of the protective glass 120 acts twice on the sample beam 70′. In contrast, the second sample beam 170′, which is generated by reflection at the second boundary surface 122, does not pass through the protective glass at all, so that the position of the intermediate focus 171′ of the second sample beam 170′ corresponds approximately to the original intermediate focus 171. The shift Δz_{PS2} of the intermediate focus of the second sample beam is thus approximately zero if a shift of the energy beam focus 76 is caused exclusively by a thermal focus shift of the protective glass. In contrast to FIG. 19, FIG. 20 shows a situation in which a thermal focus shift occurs essentially in the focusing optics 116. In this case, the magnitudes of the shift Δz_{F} of the energy beam focus 76′, the shift Δz_{PS} of the intermediate focus 71′ of the sample beam 70′, and the shift Δz_{PS2} of the intermediate focus 171′ of the second sample beam 170′ are approximately equal.

FIG. 21 schematically shows the intensity distribution 79 on the detector 40 with the two beam spot pairs 93, 94 and 193, 194 when the sample beams 70, 170 generated by the two boundary surfaces 121, 122 of the protective glass 120 are imaged onto the detector 40 with a focal position sensor 13 as shown in FIG. 18. In other respects, the illustration corresponds to the situation shown in FIG. 14, which is why reference is made to the description of FIG. 14 for further details.

FIG. 22, similar to FIG. 21, schematically shows the intensity distribution 79 on the detector 40 with the two beam spot pairs 93, 94 and 193, 194 when the sample beams 70, 170 generated by the two boundary surfaces 121, 122 of the protective glass 120 are imaged onto the detector 40 with a focal position sensor 13 as shown in FIG. 18. FIG. 22 shows a situation in which the beam spots 93 and 193 generated by the two sample beams 70 and 170, on the one hand, and the beam spots 94 and 194, on the other hand, are not completely spatially separated from each other. This situation can occur if a very thin protective glass 120 is used. The second sample beam 170, which is generated by reflection at the second (inner, or upper) boundary surface 122 of the protective glass 120, then differs only slightly in its axial position from the first sample beam 70, which is generated by reflection at the outer boundary surface 121 of the protective glass 120. Consequently, the intermediate foci 71 and 171 of the sample beams 70 and 170 then also have only a small axial distance from one another. In such a situation, the evaluation device 80 can be configured to determine an average distance m in the first lateral direction 31 between a first average position from the beam spots 93 and 193 and a second average position from the beam spots 94 and 194.

The two beam spots 93 and 193 are thus regarded as a common first beam spot. In the same way, the beam spots 94 and 194 are regarded as a common second beam spot. The mean distance m determined in this way is identical to the mean value m from the distances a and b, where a is the distance in the first lateral direction 31 between the beam spots 93 and 94 formed by the first sample beam 70, and where b is the distance in the first lateral direction 31 between the beam spots 193 and 194 formed by the second sample beam 170. In such situations, this mean distance m can alternatively be used by the evaluation device 80 as a geometry parameter for determining the focal position. A changed focal position results in changed positions of the changed beam spots 93′, 94′, 193′, 194′ and thus a correspondingly changed mean distance m′ in the first lateral direction 31.

FIG. 23 shows the use of a beam analysis device 10 according to the embodiment shown and described in FIG. 15 with a focal position sensor 13 according to the fourth embodiment of the focal position sensor in conjunction with a processing optics 200. The processing optics 200 is comparable in essential elements to the processing optics 100 already described in FIGS. 2 and 7.

In contrast to the processing optics 100, the processing optics 200 has a second protective glass 125 and a cutting device 140, which additionally has a pressure equalization connection 145. The pressure equalization connection 145 is a pneumatic connection, for example a simple open channel, between the cavity 141 and the intermediate space between the outer protective glass 120 and the second protective glass 125. As a result of the pressure equalization connection 145, the same pressure always builds up in the intermediate space between the outer protective glass 120 and the second protective glass 125 as in the cavity 141. Consequently, no differential pressure builds up on the outer protective glass 120. The protective glass 120 will therefore not bend even at a high cutting gas pressure. This has the advantage that a thin and therefore less expensive protective glass can be used as a wear part for the outer protective glass 120, while the second protective glass 125 must be designed to be pressure-resistant. Since the second protective glass 125 is protected from contamination by the outer protective glass 120, the second, thicker protective glass 125 never or only rarely needs to be replaced. Due to the lack of deflection of the outer protective glass, there is also no shift of the intermediate focus 71 in the sample beam 70 when the cutting gas pressure changes. Nevertheless, a correction dependent on the cutting gas pressure p is required when determining the focal position, because the energy beam focus 76 is shifted as a result of the increase in the refractive index of the pressurized cutting gas.

### DETAILED DESCRIPTION OF THE INVENTION

The invention solves the problem that in laser processing processes, in particular in laser cutting, the axial focal position of the laser beam can be changed as a result of the process gas, in particular the cutting gas, among other things, which is not noticed by conventional focal position sensors and can lead to an inaccurate or even incorrect measured value for the focal position. The beam analysis device 10 according to the invention comprises a beam shaping device 12, a detector 40 and an evaluation device 80. The beam shaping device 12 is configured to receive a sample beam 70. For this purpose, the beam shaping device can be coupled, for example, to a beam output of a decoupling device of processing optics 100. The processing optics 100 images an energy beam 77, in particular a laser beam 77, onto a focus 76. By means of the decoupling device, a sample beam 70 is decoupled in the beam path of the processing optics 100 and fed to the beam shaping device 12. The beam shaping device 12 and the detector 40 form a focal position sensor 13 and are preferably arranged together in a housing that can be attached to the processing optics 100.

The evaluation device 80 includes at least one input unit 84 for a detector signal 64, an input unit 83 for a cutting gas signal 63, a memory unit 81 for calibration data and/or other parameters, and a calculation unit 86 for determining a corrected focal position.

The axial focal position 76 in a laser cutting system is primarily determined by the imaging system of the processing optics 100. Deviations from a defined focal position occur primarily due to the following effects:
movement of the lens system, e.g. the collimator;
thermal focus shift in one or more optical elements of the optics, in particular in the protective glass;
pressure of the cutting gas in a cutting gas device.

The thermal focus shift is an effect that is also dependent on the contamination of the optics, in particular the protective glass, and therefore typically increases with increasing operating time. As the magnitude of this effect is therefore indeterminate and also variable over time, precise tracking of the axial focal position can only be achieved using a focal position sensor that enables continuous determination of the focal position during the processing process.

For this purpose, it is particularly advantageous to carry out a beam sampling or the generation of a sample beam 70 at the last optical boundary surface 121 of the optical system for determining the focal position, for example on the side of the protective glass 120 facing the processing process or the workpiece 150. A fraction of the laser beam 77 is reflected at this boundary surface 121. This produces the sample beam 70, which consequently has a mirror image 71 of the laser beam focus 76. This mirror image of the laser beam focus 76 is thus an intermediate focus 71 in the sample beam 70. This means that changes in the axial focus position 76 result in a proportional change in the mirrored focus or intermediate focus 71 in the sample beam 70. For example, the sample beam 70 is decoupled from the processing optics 100 by means of a beam decoupler 115 and guided to the focal position sensor 13. The beam decoupler 115 can, for example, comprise an inclined partially reflective element. The focal position sensor 13 is used to determine a change in the focal position in the sample beam 70, i.e. the focal position of the intermediate focus 71, and the proportional change in the focal position 76 of the laser beam 77 is determined from this.

Accordingly, the focal position sensor 13 is able to detect all changes in the focal position that have their cause in the optical system of the processing optics 100. However, the focal position sensor 13 cannot detect any changes whose causes lie outside the optical system. These causes include, in particular, a cutting gas 146 supplied to the process under pressure.

During laser cutting, a cutting gas 146 is supplied to the cutting process by means of a cutting gas device 140, which serves, among other things, to blow the molten material out of the cutting gap.

For this purpose, the cutting gas device 140 has a cavity 141 which extends from the protective glass 120 to a cutting nozzle 142. The cutting gas 146 is supplied to the cavity 141 via a cutting gas supply 143 and leaves the cavity 141 through the bore of the cutting nozzle 142 coaxially to the focused laser beam 77. The cutting gas 146 is under a high pressure p′ and therefore has an increased refractive index n′. Due to the, even if only slight, increase in the refractive index n within the cavity 141, the laser beam 77 is refracted, i.e. the optical path within the cavity 141 changes, as a result of which its axial focal position 76 is shifted.

This change in the focal position cannot be detected by the focal position sensor 13, since the sample beam 70 does not pass through the cavity 141 of the cutting gas device 140 due to the principle of operation.

However, the change in the focal position 76 caused by the cutting gas 146 can certainly be a noticeable amount, as the following numerical example shows.

The following typical parameters are assumed: the distance L covered by the laser beam 77 within the cutting gas device 140 is L=100 mm, the cutting gas 146 is nitrogen at a pressure of p′=20 bar.

The refractive index of nitrogen at normal pressure and room temperature is n₀=1.00028.

The refractive index of a gas as a function of pressure p and temperature T is given by the following equation:

$$n - 1 = {n}_{0} - 1 ) p / {p}_{0} ) ( {T}_{0} / T )$$

At a pressure of p′=20 bar, this gives n′=1.0056 for nitrogen. The change in the back focal length Δz, i.e. the axial focal position 76 of the laser beam 77, is obtained from the following formula:

$$Δ z = L ( {n}^{′} - 1 ) / {n}^{′}$$

The change in the focal position in this example is therefore Δz=0.56 mm.

If normal compressed air is used as the cutting gas instead of nitrogen, the numerical values are almost identical.

However, the high pressure of the cutting gas 146 has a further effect: it causes very slight deflection of the protective glass 120, so that the boundary surface 121, at which the sample beam 70 is generated by partial reflection, is no longer planar. As a result, the mirrored focus 71 in the sample beam 70 is also shifted slightly.

This shift can also be calculated, which is shown below by a typical numerical example.

For this purpose, a protective glass 120 made of quartz glass with a thickness d=5 mm and a diameter 2R_{PG}=30 mm is assumed. The modulus of elasticity E of the protective glass material is also required for the calculation, which is E=72500 N/mm² for quartz glass. The deflection w in the center of a circular plate hinged at the edge is calculated according to the following formula

$$w = 0.696 p {R}_{P G}^{4} / ( {Ed}^{3} )$$

to w=0.0078 mm. The radius of curvature R_{C} of the plate, i.e. of the protective glass 120, is obtained from the following formula:

$${R}_{C} = ( {w}^{2} + {R}_{PG}^{2} ) / 2 w \approx {R}_{PG}^{2} / 2 w$$

The numerical values given as an example result in a radius of curvature of the two protective glass surfaces 121, 122 of R_{C}=14.4 m.

This means that the protective glass 120, which is under pressure from the cutting gas 146, acts on the sample beam 70 like a very weak convexly curved mirror with a focal length of −f_{Refl}=R_{C}/2=7200 mm. With a distance of the laser beam focus 76 of L=100 mm to the protective glass 120, this results in an axial displacement of the mirrored beam focus 71 in the sample beam 70 of Δz=L²/ f_{Refl}=−1.4 mm.

In the numerical example selected, the focal position sensor would therefore detect an apparent shift in the axial focal position of 1.4 mm, while the true shift in the axial focal position is 0.56 mm.

In this numerical example, the focal position sensor would therefore overestimate the change in the focal position by a factor of 1.4/0.56=2.5. The size of this factor can therefore be determined or calculated directly from the parameters of the protective glass, the cutting device, and the pressure of the cutting gas. The value of this factor can also be obtained from a previous calibration.

The parameters of the protective glass and the cutting device are constant parameters for given processing optics, while the pressure of the cutting gas can be variable. Both the change in the position of the energy beam focus 76 due to the refractive index n of the cutting gas and the change in the position of the intermediate focus 71 in the sample beam 70 are approximately proportional to the magnitude of the cutting gas pressure p, at least for small changes.

Thus, in particular, the current cutting gas pressure p determines the current deviation between a change in the position of the energy beam focus 76 and a change in the position of the intermediate focus 71 in the reflected sample beam 70, which is detected by the focal position sensor. In order to correct this deviation, which the focal position measurement value primarily determined by the evaluation device 80 from the data from the focal position sensor 13 may have, and to distinguish it from changes in the focal position resulting from other causes such as a collimator adjustment or a thermal focus shift, the evaluation device 80 requires information as to whether the cutting gas 146 is switched on and/or information representing the level of the cutting gas pressure p.

The evaluation device 80 of the beam analysis device 10 according to the invention therefore includes an input unit 83 for a cutting gas signal 63, a memory unit 81 for calibration data and/or other parameters, and a calculation unit 86 for determining a corrected focal position.

The input unit 83 for the cutting gas signal 63 can be, for example, a physical interface for an electrical line, or a virtual interface in a computer program, or a wireless interface for a radio transmission of data.

In a particularly simple embodiment example, the cutting gas signal 63 can be a binary signal whose two states represent different pressures. For example, a first state can be a state in which no cutting gas 146 is supplied (cutting gas is switched off), and in a second state a cutting gas 146 is supplied at a predefined pressure (cutting gas is switched on). The binary signal can just as well represent two different predefined pressures of a supplied cutting gas 146, e.g. a low pressure p₁ for the piercing process and a high pressure p₂ for the cutting process. Which pressure the value of the signal 63 corresponds to in each case can be stored in the memory unit 81 as a calibration.

The cutting gas signal 63 can also be an analog or digital signal that is proportional to the cutting gas pressure. Using the current cutting gas signal 63, the calculation unit 86 can then determine a correction value by means of a proportionality factor stored or calibrated in the memory unit 81 and thus determine the corrected focal position.

The values of various parameters required for the calculations of the calculation unit 86 are preferably stored in the memory unit 81. The parameters may be proportionality factors and/or constants determined from a calibration process. The calibration data can, for example, describe a change in the geometry parameter as a function of the gas pressure signal. The parameters can also be various properties of the optical system, the cutting device and the protective glass, e.g. magnification of the optics, focal lengths of the collimator optics and focusing optics, refractive index of the cutting gas, transmitted length of the cavity of the cutting device, radius or diameter of the protective glass, thickness of the protective glass, modulus of elasticity of the protective glass, and/or other parameters if necessary. One or more of the proportionality factors and/or constants required for the calculations can then be determined or adjusted from this data, for example if a protective glass with a different thickness is used when the protective glass is changed. For this purpose, the memory unit can also have an interface or a port for entering or updating one or more parameters.

Alternatively or additionally, a correction value can be stored in the memory unit 81 for at least one state of the cutting gas signal 63 or for at least one magnitude value of the cutting gas signal 63, which is used by the calculation unit 86 to correct the focal position determined by the focal position sensor 13. The correction value or the correction values may have been previously determined in a calibration cycle. The correction value required in each case can be linked to the value or the state of the cutting gas signal 63 via a look-up table. If intermediate values are required, the calculation unit 86 can perform an interpolation between the values of the look-up table.

The cutting gas signal 63 can, for example, correspond to the state of a switching valve with which the cutting gas is switched on or off, or with which different pressures of the cutting gas 146 are set.

The cutting gas signal 63 can also be a pressure specification signal or pressure target signal from a higher-level system controller. A controllable valve can then be used to set the pressure requested in accordance with the specification.

The cutting gas signal 63 can be the measured value of a gas pressure sensor 62 and can be provided by the same. The measured value of the gas pressure sensor 62 can be fed directly into the input unit 83 of the evaluation device 80 via a data connection. Alternatively, the gas pressure sensor 62 can also be connected to a higher-level system controller, which then transmits the cutting gas signal 63 to the evaluation unit 80 or to the input unit 83 of the evaluation unit 80 via the data connection.

The gas pressure sensor 62 can be arranged inside the cutting gas device 140. For this purpose, the gas pressure sensor 62 can be arranged, for example, in a niche of the cavity 141.

The gas pressure sensor 62 can also be coupled to the cavity 141 of the cutting gas device 140 via a pneumatic connection.

The gas pressure sensor 62 can also be arranged at any position of the cutting gas supply 143 or be pneumatically connected to the supply of the cutting gas.

The focal position sensor 13 includes the beam shaping device 12 and the detector 40. The beam shaping device 12 is arranged to receive the sample beam 70 and image the sample beam 70 onto the detector 40, thereby producing an intensity distribution 79 on the detector 40. The detector 40 includes a radiation-sensitive sensor having a two-dimensional resolution, which converts the intensity distribution 79 into electrical signals 64.

The evaluation device 80 processes the detector signals 64. For this purpose, the evaluation device 80 is equipped with an input unit 84 for receiving the detector signals 64. The input unit 84 for the detector signals 64 can be, for example, a physical interface for an electrical line, or a virtual interface in a computer program, or a wireless interface for radio transmission of detector data.

The evaluation device 80 is configured to determine a geometry parameter from the detector signal 64, which represents the intensity distribution 79. The geometry parameter represents a specific geometric property of the intensity distribution 79. The geometry parameter may describe a geometric value of an essential feature of the intensity distribution 79. The geometry parameter can thus be a value to which a unit of length can be assigned, such as mm (millimeters) or μm (micrometers), or to which a unit of area can be assigned, such as mm² (square millimeters) or μm² (square micrometers). This geometry parameter can be, for example, a diameter Ø of a beam spot 91 of the intensity distribution 79, or a distance a between two beam spots 93, 94 of the intensity distribution 79, or another comparable geometric parameter of the intensity distribution 79. The geometry parameter is explained in more detail below in individual embodiments.

The magnitude of the geometry parameter is directly dependent on the axial position of the intermediate focus 71 of the sample beam 70 and thus on the axial position of the energy beam focus 76 of the laser beam 70, because the intermediate focus 71 is a mirrored focus of the energy beam focus 76. The evaluation device 80 determines the axial position of the energy beam focus 76 from the geometry parameter, taking into consideration the cutting gas signal 63. For this purpose, the evaluation device 80 includes a calculation unit 86 and a memory unit 81.

The determination of the position or a change in the position of the energy beam focus 76 can proceed in the manner described below.

The evaluation device 80 first determines a primary, uncorrected geometry parameter, for example a distance a between two beam spots 93, 94, from the detector signals 64 by means of the calculation unit 86.

From this distance a, a corrected geometry parameter is determined taking into consideration the cutting gas signal 63, or taking into consideration the pressure p associated with the value of the cutting gas signal 63, i.e. in this case a corrected distance a_{corr}, for example according to the following scheme:

$${a}_{c o r r} = a + p [ {c}_{1} + {c}_{2} ( a ) ]$$

The term p[c₁+c₂(a)] therefore forms a correction value for the geometry parameter in this calculation scheme.

Here, c₁ is a constant parameter and c₂ is a function that can be dependent on the uncorrected geometry parameter, for example in simple linear form c₂(a)=c′₂ a. The parameters c₁ and c₂ or c′₂ can be stored in the memory unit 81. The parameters c₁ and c₂ or c′₂ may have been determined in a calibration process carried out in advance. The parameter c₂ or c′₂ can also be zero. In embodiments intended for use on processing optics with an adjustable collimator, the parameters c₁ and c₂ or c′₂ can individually or both contain a term dependent on a collimator setting z_{Coll}, so that the following scheme can be used for the correction of the geometry parameter, for example:

$${a}_{c o r r} = a + p [ {c}_{1} + {c}_{2} ( a ) + {c}_{K} ( {z}_{Coll} ) ]$$

In a linear approximation, the following formula can be used to correct the geometry parameter, whereby c₁, c₂′, c_{K}′ are then constant coefficients:

$${a}_{c o r r} = a + p ( {c}_{1} + {c}_{2}^{′} a + {c}_{K}^{′} {z}_{Coll} )$$

Finally, the corrected geometry parameter or the corrected distance a_{corr} is used to determine the axial focus position z_{F} of the energy beam focus 76, or a change in the axial position Δz_{F}=z_{F}−z₀, for example according to the following scheme:

$$Δ {z}_{F} = g {a}_{c o r r} - {z}_{0}$$

The parameter z₀ can be a start position of the focal position, or a nominal position, or a zero position, or a previous focus position determined in a previous step.

For the most accurate possible representation of the focal position z_{F} as a function of the corrected geometry parameter a_{corr}, the function for calculating the focus position z_{F} can also be dependent on higher powers of the corrected geometry parameter a_{corr}. In particular, the function can have a quadratic component:

$$Δ {z}_{F} = {g}_{1} {a}_{c o r r} + {g}_{2} {a}_{c o r r}^{2} - {z}_{0}$$

The parameter g or the parameters g₁ and g₂ can be constant coefficients that are stored in the memory unit 81. If the processing optics 100 has a device for adjusting the energy beam focus 76, for example with an axially adjustable collimator 113, then the parameters g or the parameters g₁ and g₂ can be functions g=g(z_{Coll}) dependent on the collimator optics position z_{Koll}. This means that the functions g or g₁ and/or g₂ can contain one or more terms dependent on z_{Koll}. For example, the formula used to determine the focal position can be represented as follows:

$$Δ {z}_{F} = ( {g}_{10} + {g}_{11} {z}_{Coll} + {g}_{12} {z}_{Coll}^{2} ) {a}_{c o r r} + ( {g}_{20} + {g}_{21} {z}_{Coll} + {g}_{22} {z}_{Coll}^{2} ) {a}_{c o r r}^{2} - {z}_{0}$$

The parameters g₁₀, g₁₁, g₁₂, g₂₀, g₂₁, g₂₂ are constant coefficients whose values can also be zero in some cases, depending on the constellation of the entire system.

Naturally, the various units and modules of the evaluation device 80 do not have to be designed as separate units. All modules of the evaluation device 80 can be designed as functional units of a digital information processing device, such as a microcomputer. Individual or all modules of the evaluation device 80 can be realized as a computer program which runs on a conventional microcomputer or a personal computer. An embodiment is provided in which the evaluation device 80 is integrated into the housing in which the focal position sensor 13 is also arranged.

Embodiments are also provided in which the evaluation device 80 is not integrated in the housing of the focal position sensor 13.

A beam analysis method is also provided in which the focal position is additionally determined taking into consideration an offset dependent on the thickness of the protective glass (120).

In a further possible beam analysis method, the calibration data can be adjusted as a function of the thickness of the protective glass (120).

Furthermore, a beam analysis method is provided in which calibration data is determined before the start of the actual laser processing, in particular after changing a protective glass (120), by determining the geometry parameter for at least two different cutting gas pressure settings at low laser power.

Which variable is used as the geometry parameter, which is determined by the evaluation device 80 from the intensity distribution 79 on the detector 40, can depend on the embodiment of the focal position sensor 13. The focal position sensor 13 comprises at least the beam shaping device 12 and the detector 40.

### First Embodiment of a Focal Position Sensor

A first embodiment of the focal position sensor 13 of the beam analysis device 10 is shown in FIGS. 8 and 9. In a first possible embodiment of the focal position sensor 13, the beam shaping device 12 comprises an imaging device 50 with an optical lens 51. By means of the imaging device 50, the sample beam 70 is imaged onto the detector 40. In the first embodiment of the focus position sensor, for example, the entire sample beam 70 received by the beam shaping device 12 is focused onto the detector 40, where it forms a beam spot 91 with a diameter Ø of the beam spot 91. Consequently, an image of the intermediate focus 71 of the sample beam 70 is generated in the vicinity of the detector 40. The distance of the image of the intermediate focus 71 depends on the axial position of the intermediate focus 71 and is thus also coupled to the axial position of the energy beam focus 76 of the laser beam 77 from which the sample beam is generated. Depending on the distance of the image of the intermediate focus 71 to the detector 40, the diameter Ø of the beam spot 91 on the detector 40 varies. The diameter Ø is minimal if the image of the intermediate focus 71 lies exactly in the plane of the detector 40. The larger the distance between the image of the intermediate focus 71 and the detector 40, the larger the diameter Ø of the beam spot 91. Consequently, the axial position of the beam focus 71 and thus the axial position of the energy beam focus 76 can be determined from the size of the diameter Ø. In this first embodiment of the focal position sensor 13, the diameter Ø of the beam spot 91 on the detector 40 is therefore the geometry parameter which is determined by the evaluation device 80 from the intensity distribution 79 with the beam spot 91.

### Second Embodiment of a Focal Position Sensor

A second embodiment of the focal position sensor 13 of the beam analysis device 10 is shown in FIG. 10. In a second possible embodiment of the focal position sensor 13, the beam shaping device 12 comprises a lens array 56. The beam shaping device 12 may further comprise an imaging device 50 with which the sample beam 70 is initially collimated. The lens array 56 includes a plurality of individual lens elements 57, also referred to as lenslets 57, arranged side-by-side in a plane. The individual lens elements 57 each image a portion of the sample beam 70 onto the detector, so that an intensity distribution 79 with a plurality of beam spots is generated on the detector 40. The detector 40 can be arranged approximately at a distance from the lens array 56 that corresponds to the focal length of the individual lens elements 57 of the lens array 56. In this second embodiment example, the lens array 56 and the detector 40 form a so-called wavefront sensor, the mode of operation of which is known from the prior art and which therefore does not need to be explained in more detail here. The wavefront of the sample beam 70 can be reconstructed from the distances a_{N1} . . . a_{NM} of the individual beam spots to one another and the axial position of the beam focus 71 and thus the axial position of the energy beam focus 76 can in turn be determined from this. In this second embodiment of the focal position sensor 13, one or more of the distances a_{N1} . . . a_{NM} of the beam spots from one another therefore form the geometry parameter, which is determined by the evaluation device 80 from the intensity distribution 79 with the plurality of beam spots.

### Third Embodiment of a Focal Position Sensor

A third embodiment of the focal position sensor 13 of the beam analysis device 10 is shown in FIGS. 11 and 13. In a third possible embodiment of the focal position sensor 13, the beam shaping device 12 comprises an imaging device 50 with an optical lens 51 and a modulation device 20 with a blocking zone 25 and two transmission zones 23, 24. By means of the modulation device 20, two partial beams 73, 74 are extracted from the sample beam 70. For this purpose, the modulation device 20 has the two transmission zones 23, 24, which may e.g. be circular openings of a double aperture diaphragm. By means of the imaging device 50, the partial beams 73, 74 extracted from the sample beam 70 are imaged onto the detector 40 to form an intensity distribution 79 with two beam spots 93, 94. To ensure that the two beam spots 93, 94 on the detector are laterally separated from one another, the distance between the imaging device 50 and the detector 40 and the focal length of the imaging device 50 are selected such that the image of the intermediate focus 71 is preferably not formed in the plane of the detector 40, but either in the beam direction in front of the detector 40 or behind it. Consequently, the two beam spots 93, 94 then have a distance a from each other, the size of which is dependent on the axial position of the intermediate focus 71 of the sample beam 70 and thus on the axial position of the energy beam focus 76 of the laser beam 77.

Consequently, the axial position of the beam focus 71 and thus the axial position of the energy beam focus 76 can be determined from the size of the distance a. In this third embodiment of the focal position sensor 13, the distance a of the beam spots 93, 94 on the detector 40 therefore forms the geometry parameter, which is determined by the evaluation device 80 from the intensity distribution 79 with the beam spots 93, 94.

### Fourth Embodiment of a Focal Position Sensor

A fourth embodiment of the focal position sensor 13 of the beam analysis device 10 is shown in FIGS. 12 and 14 to 17. In a fourth preferred embodiment of the focal position sensor 13, the beam shaping device 12 comprises an imaging device 50 with an optical lens 51, a modulation device 20, and a beam separator device 52 with at least one partial beam deflector element 53, 54.

In the fourth embodiment of the focal position sensor 13, the beam shaping device 12 is configured to extract at least two partial beams 73, 74 from the sample beam 70 in a plane of the partial beam extraction 19. The cross-section of each partial beam 73, 74 in the plane of the partial beam extraction 19 is defined by a respective partial aperture 33, 34. In other words, the beam shaping device 12 is configured to form the at least two partial apertures 33, 34 in the plane of the partial beam extraction 19 for extracting a respective partial beam 73, 74. The partial apertures 33, 34 are delimited from each other, i.e. the edges of the partial apertures 33, 34 do not touch each other. The lateral positions of the partial apertures 33, 34 are defined by their respective centers, whereby the term “lateral” refers to directions in planes perpendicular to the respective local optical axis 11.

The centers of the partial apertures 33, 34 are at a distance k from one another. Furthermore, a first lateral direction 31 is defined by the distance k between the partial apertures 33, 34. In other words, an imaginary connecting line between the centers of the two partial apertures 33, 34 defines the first lateral direction 31. The first lateral direction 31 lies in a plane that is perpendicular to the local optical axis 11. Since the local optical axis 11 in a beam path is always identified with a z-axis of a local coordinate system, the first lateral direction 31 therefore lies in an x-y plane. The partial beam extraction of the beam shaping device is realized, for example, as a modulation device 20, which is configured to form at least two transmission zones 23, 24 and at least one blocking zone 25. In each case, one of the transmission zones 23, 24 forms one of the two partial apertures 33, 34. The transmission zones 23, 24 are characterized in that a transmissivity for the radiation within the transmission zones 23, 24 is substantially greater than in the region of the blocking zone 25. The term transmissivity is to be understood here with regard to the intended propagation direction of the partial beams 73, 74 extracted in this way. In particular, a radiation transmittance (or reflectance) in the transmission zones 23, 24 is at least twice as high as a radiation transmittance (or reflectance) in the blocking zone 25. Preferably, the radiation transmittance (or reflectance) in the blocking zone 25 is at least 10 times smaller than the radiation transmittance (or reflectance) in the transmission zones 23, 24. Particularly preferably, the radiation transmittance (or reflectance) in the blocking zone 25 is at least 100 times smaller than the radiation transmittance (or reflectance) in the transmission zones 23, 24.

The partial apertures 33, 34 have a width b in the plane of the partial beam extraction 19 along the first lateral direction 31. The width b of the partial apertures 33, 34 is at most equal to half the distance k between the centers of the partial apertures 33, 34. It follows from this that between the partial apertures 33, 34 there is an area, for example a blocking zone 25, which is at least as wide as the width b of the partial apertures 33, 34. In other words, the distance k between the centers of the partial apertures 33, 34 is at least twice the width b of the partial apertures 33, 34.

The beam shaping device 12 is further arranged for shaping an intensity distribution 79 on the detector 40 with at least two beam spots 93, 94 and for forming at least one beam spot 93, 94 from each of the two partial beams 73, 74, to image the at least two partial beams 73, 74 onto the detector 40 and to deflect and/or displace at least one of the at least two partial beams 73, 74 in a second lateral direction 37. Each of the two partial beams 73, 74 forms at least one associated beam spot 93, 94 on the detector 40. By deflecting and/or displacing at least one of the partial beams 73, 74 in the second lateral direction 37, a distance w is formed between the positions of the two beam spots 93, 94 on the detector 40 along the second lateral direction 37. Preferably, the positions of the two beam spots 93, 94 are defined by the centers and/or by the centroids of the intensity distributions of the beam spots 93, 94 on the detector 40. The second lateral direction 37 is oriented transversely to the first lateral direction 31. The second lateral direction 37 lies in a plane that is perpendicular to the local optical axis 11. Thus, like the first lateral direction 31, the second lateral direction 37 lies in a plane perpendicular to the local optical axis 11, i.e. in an x-y plane. The second lateral direction 37 is aligned, for example, at an angle in the range of 30° to 150° to the first lateral direction 31. In particular, the second lateral direction 37 can be aligned (at least substantially) perpendicular to the first lateral direction 31.

By the beam shaping device 12 deflecting and/or displacing the first of the at least two partial beams 73, 74 in the second lateral direction 37 and/or deflecting and/or displacing both partial beams 73, 74 in different directions with a directional difference in an orientation along the second lateral direction 37, the beam spot 93 of the first of the at least two partial beams and the beam spot 94 of the second of the at least two partial beams are offset from each other (at the detector 40 and thus) in the intensity distribution 79 along the second lateral direction 37 by the distance w which is transverse to the distance a of these beam spots 93, 94 (at the detector 40 and thus) in the intensity distribution 79 along the first lateral direction 31 and wherein the distance a is caused solely by the distance k in the first lateral direction 31.

In other words, the beam spot 93, which is caused by the first of the at least two partial beams at the detector 40 and in the intensity distribution, and the beam spot 94, which is caused by the second of the at least two partial beams at the detector and in the intensity distribution, are additionally offset in the intensity distribution by the offset w along the second lateral direction 37 in addition to the distance a along the first lateral direction 31.

The detector 40 comprises a sensor which is sensitive to light radiation and has a two-dimensional spatial resolution and which is configured to convert the intensity distribution 79 incident on the detector 40 into electrical signals. The detector 40 may be a CCD camera or a CMOS camera or a comparable device. The sensor, which is sensitive to light radiation and has a two-dimensional spatial resolution, is typically a pixel-based semiconductor sensor. The detector 40 is arranged along a propagation path for the partial beams 73, 74 at a distance s behind the plane of the partial beam extraction 19.

The evaluation device 80 is configured to process the electrical signals 64 of the detector 40, which represent the intensity distribution 79 on the detector 40. The evaluation device 80 is configured to determine a geometry parameter from the intensity distribution 79. In the fourth embodiment of the focal position sensor 13 shown here, the geometry parameter preferably corresponds to the distance a along the first lateral direction 31 between positions of the two beam spots 93, 94 on the detector 40. More precisely, the evaluation device 80 is thus configured to determine a position difference of the two beam spots 93, 94 in the first lateral direction 31, wherein the position difference of the two beam spots 93, 94 in the first lateral direction 31 is the distance a. Preferably, the position of the respective beam spot 93, 94 is defined by the center point and/or by the centroid of the intensity distribution of the respective beam spot 93, 94 on the detector 40.

The size of the distance a between the beam spots 93, 94 in the first lateral direction 31 is dependent on the axial position of the intermediate focus 71 of the sample beam 70 and thus on the axial position of the energy beam focus 76 of the laser beam 77. Consequently, the axial position of the beam focus 71 and thus the axial position of the energy beam focus 76 can be determined from the size of the distance a in the first lateral direction 31. In this fourth embodiment of the focal position sensor 13, the distance a of the beam spots 93, 94 formed in the first lateral direction 31 on the detector 40 therefore forms the geometry parameter, which is determined by the evaluation device 80 from the intensity distribution 79 with the beam spots 93, 94.

The focal position sensor 13 is used to determine the axial position of the energy beam focus 76. In this respect, the formulae given below for calculating the position of the intermediate focus 71 from the distance a initially form an intermediate result. In the final determination of the position of the energy beam focus 76, the imaging of the sample beam 70 by the focusing optics 116 of the processing optics 100 must still be taken into consideration, because the decoupling of the sample beam 70 by means of the beam decoupler 115 usually takes place in the collimated region of the processing optics 100 between the focusing optics 116 and the collimator optics 113.

The basic relationship between the position of the energy beam focus 76 and the intermediate focus 71 of the sample beam 70 has already been explained above. In the simplest case, if the refraction of the sample beam 70 by the focusing optics 116 can be neglected, the intermediate focus 71 is a mirror image of the energy beam focus 76, so that a change in position of the intermediate focus 71 is opposite to and equal to a change in position of the energy beam focus 76. The refraction of the sample beam 70 by the focusing optics 116 is negligible if the intermediate focus 71 is close to or even exactly in the same plane as the focusing optics 116. In many typical embodiments of a processing optic, particularly a cutting optic, the intermediate focus 71 is relatively close to the focusing optic 116 because the protective glass 120 is often located approximately halfway between the focusing optic 116 and the energy beam focus 76. Furthermore, the refraction of the sample beam 70 by the focusing optics 116 is already included in the proportionality factors and constants generated during calibration as a result of the calibration of the focal position sensor 13 and therefore does not have to be taken into consideration separately in the evaluation algorithm.

The formulas given below as examples for calculating the position of the intermediate focus 71 can therefore also be used with a comparable mathematical structure for calculating the position of the energy beam focus 76. This may result in slightly different proportionality factors and constants.

When the axial position of the intermediate focus 71 of the sample beam changes, the distance a between the beam spots 93, 94 on the detector 40 changes in the first lateral direction 31. This means that the distance a is in a functional relationship to the z-position of the intermediate focus 71 and thus to the z-position of the energy beam focus 76. This functional relationship is influenced and/or defined by the following geometric variables:
a is the distance along the first lateral direction 31 between the beam spots 93 and 94 on the detector 40;
a′ is the distance along the first lateral direction between the beam spots 93′ and 94′ on the detector 40 when the beam focus position is changed;
Δa is the change in the position differences of the beam spots 33, 34 in the first lateral direction 31, Δz=a′−a;
k is the distance between the centers of the partial apertures 33, 34 in the plane of the partial beam extraction 19, whereby the imaginary connecting line between the centers of the partial apertures 33, 34 defines the first lateral direction 31;
z_{PS} is the distance between the axial position of the intermediate focus 71 of the sample beam 70 and the plane of the partial beam extraction 19;
z_{PS}′ is the distance between the axial position of a displaced intermediate focus 71′and the plane of the partial beam extraction 19;
Δz_{PS} is the change in the axial intermediate focus position, Δz_{PS}=z_{PS}′−z_{PS};
s is the distance between the plane of the partial beam extraction 19 and the sensor plane 39 of the detector 40;
d is the distance from the position of the imaging device 50, or more precisely, from the principal plane of the imaging device 50, to the plane of the partial beam extraction 19.

From the application of the theorems of intersecting lines and the known imaging equations, the following functional relationship is obtained for the focal position sensor of the beam analysis device 10:

$$Δ {z}_{P S} = Δ a {c}_{3} / ( {c}_{4} + Δ a {c}_{5} )$$

The formula symbols c₃, c₄, c₅ are coefficients that have been introduced to simplify the representation of the formula.

In the case that the modulation device 20 is arranged behind the imaging device 50, the coefficients c₃, c₄, c₅ are as follows:

$${c}_{3} = {[ {z}_{PS} ( f - d ) + {d}^{2} ]}^{2}$$

$${c}_{4} = {f}^{2} ks$$

$${c}_{5} = ( f - d ) [ {z}_{PS} ( f - d ) + {d}^{2} ]$$

The coefficients c₃, c₄, c₅ can be determined by setting at least 3 different known axial positions of the intermediate focus 71 or the energy beam focus 76 and determining the corresponding change Δa of the distance a. The coefficients determined in this way can be stored as calibration data in the evaluation device 80, with which the change in focal position Δz_{F} can then be calculated by the evaluation device 80 for any changes in distance Δa.

Alternatively or additionally, the coefficients can be calculated directly from the geometric distances of the arrangement using the formulae given above and stored in the evaluation device 80.

It should be noted that all axial distances, i.e. z_{PS}, d, f, s, are the distances along the optical axis 11.

In the case of beam deflection, the distances z_{PS}, d, f, s, may therefore be composed of the respective distances along the local optical axes 11. It should also be noted that if the beams are partially guided by optical material, such as when they are guided by a beam splitter cube, the corresponding partial distances must be corrected by a factor that depends on the refractive index of the optical material.

In one embodiment of the beam analysis device 10 with the modulation device 20 behind the imaging device 50, that is, in the beam direction behind the at least one optical lens 51, there is a particularly interesting special case in which the distance d from the principal plane of the imaging device 50 to the plane of the partial beam extraction 19 is equal to the focal length f of the imaging device 50. In other words, the plane of the partial beam extraction 19 is arranged at the image-side focal point of the imaging device 50. For such an embodiment of the beam analysis device 10, the coefficients of the functional relationship result in:

$${c}_{3} = {f}^{4}$$

$${c}_{4} = {f}^{2} ks$$

$${c}_{5} = 0$$

This results in a particularly simple functional relationship with the special feature that the change Δa of the distance a between the beam spots 93, 94 is exactly proportional to the change Δz_{PS} of the axial intermediate focus position:

$$Δ {z}_{PS} = Δ {af}^{2} / ( ks )$$

This linear relationship simplifies the calibration of the device and achieves a high level of accuracy when determining the focal position.

It is particularly advantageous with such an arrangement that the absolute z-position of the intermediate focus 71 (z_{PS}) or the energy beam focus 76 (z_{F}) is not required to calculate a focal position change Δz_{F}.

This feature or arrangement can be advantageously realized in embodiments in which a distance between the imaging device 50 and the modulation device 20 is provided anyway, for example if the modulation device 20 is arranged in a folded beam path.

In order to achieve the highest possible accuracy in determining the positions of the beam spots 93, 94 on the detector 40, it is favorable if the width b of the partial apertures 33, 34 is small compared to their distance k. Then the beam spots 93, 94 on the detector 40 are relatively small over a wide range of the axial position of the beam focus 71 and a possible influence of an intensity distribution within the beam spots 93, 94 on the determination of the position of the beam spots 93, 94 is small or completely negligible. On the other hand, the partial apertures should not be too small, since otherwise the beam spots 93, 94 can be widened by diffraction and diffraction structures can arise outside the beam spots 93, 94. Preferably, the spacing k is therefore at least 2.5 times and at most 25 times the width b of the partial apertures 33, 34. Particularly preferably, the spacing k is at least 3 times and at most 12 times the width b of the partial apertures 33, 34. Most preferably, the spacing k is at least 4 times and at most 7 times the width b of the partial apertures 33, 34. Preferably, the partial apertures 33, 34 have a simple geometric shape, for example circular or elliptical. However, the partial apertures 33, 34 can also have a square, rectangular, diamond-shaped, hexagonal, octagonal, trapezoidal, or similar shape. In the case of partial apertures 33, 34 with a circular shape, the width b corresponds to the diameter of the partial apertures 33, 34.

In a further development of the invention, the beam shaping device 12 can also be configured to extract more than two partial beams. For this purpose, more than two, for example 3 or 4, mutually delimited partial apertures can be arranged in the plane of the partial beam extraction 19. The multiple partial apertures can all be distributed along the first lateral direction 31. It is also possible that the additional sub-apertures to the two partial apertures 33, 34 are arranged in a different lateral direction than the two partial apertures 33, 34 in the plane of the partial beam extraction 19.

Preferably, the beam shaping device 12 comprises a beam separator device 52 for deflecting and/or displacing the first of the at least two partial beams 73, 74 in the second lateral direction 37.

In a further embodiment, the beam separator device 52 is further arranged for deflecting and/or displacing both partial beams 73, 74 in different directions, the difference in the deflection directions being aligned along the second lateral direction 37.

In the embodiment example of the fourth focal position sensor 13, the beam shaping device 12 of the beam analysis device 10 comprises a modulation device 20, an imaging device 50 with at least one optical lens 51, and a beam separator device 52. These three devices 20, 50, 52 can be realized as separate devices. However, two of the three devices or all three devices 20, 50, 52 may also be realized as a unitary device. For example, the modulation device 20 can be realized as a double aperture diaphragm. The imaging device 50 can, for example, be designed as a single converging lens 51. However, it is also possible, for example, to provide the modulation device 20 as a masking device, for example by means of partial blackening, directly on or in the optical lens 51. In this latter example, the modulation device 20 and the imaging device 50 are realized as a unitary device. To continue this example, the optical lens 51 could also be designed as an aspherical free-form lens in which the lens surfaces within the partial apertures 33, 34 have an additional tilt for deflecting the partial beams 73, 74 in the second lateral direction 37. In such an embodiment example for the beam shaping device 12, all devices 20, 50, 52 are then realized in a unitary device.

The first lateral direction 31 can be defined locally. It is (at least essentially) perpendicular to the local optical axis 11. In particular, it can be defined as the direction in a plane perpendicular to the local optical axis 11 along which the at least two partial beams 73, 74 are spaced apart in this plane only due to the distance k between the partial apertures 33, 34.

The second lateral direction 37 can be defined locally. In each case, it is (at least substantially) perpendicular to the optical axis 11 and transverse to the (local) first lateral direction 31. The second lateral direction 37 can be changed globally once or several times, for example by beam folding and/or beam deflection.

A beam direction can be defined locally. The beam direction can change globally, for example due to beam folding and/or beam deflection. The local beam direction may, for example, be defined by a direction of a local Poynting vector of the sample beam 70.

In the direction of propagation of the radiation downstream of the plane of partial beam extraction 19, a local beam direction of a partial beam 73, 74 can be defined by a direction of a local Poynting vector of the respective partial beam 73, 74.

In the direction of propagation of the radiation downstream of the plane of the partial beam extraction 19, a local (overall) beam direction can be defined by an averaging of the local Poynting vectors of the at least two partial beams 73, 74. The magnitudes of the Poynting vectors of these partial beams can be normalized before averaging. Alternatively, the local (overall) beam direction can be defined by the Poynting vector of a fictitious course of the sample beam without extraction of the partial beams.

The local optical axis 11 can, for example, be defined by the intended local overall beam direction during operation.

In a further development of the invention, the beam analysis device 10 can be configured to identify a plurality of beam spots 93, 94, 193, 194 in the intensity distribution 79 on the detector 40 and to determine their distances from one another in the first lateral direction. The beam analysis device 10 is preferably equipped for this purpose with a focal position sensor 13 according to the fourth embodiment example. This means that the focal position sensor 13 in this further development is preferably equipped with a modulation device 20 for extracting preferably two partial beams from a sample beam. If several axially superimposed sample beams 70, 170 are irradiated into the beam analysis device 10, the modulation device 20 forms a beam spot pair 93, 94 and 193, 194 in the intensity distribution 79 on the detector 40 from each sample beam 70, 170. In particular, the beam analysis device 10 can thus be configured to identify a first beam spot pair 93, 94 in the intensity distribution 79, which is formed from a first sample beam 70 by means of the modulation device 20, and furthermore to identify a second beam spot pair 193, 194, which is formed from a second sample beam 170 by means of the modulation device 20. The evaluation device 80 can be configured to determine a first distance a between the beam spots 93, 94 in the first lateral direction 31, which are formed by the separation of the partial beams from the first sample beam 70, and to determine a second distance b between the beam spots 193, 194 in the first lateral direction 31, which are formed by the separation of the partial beams from the second sample beam 170. The distance a is then, for example, the geometry parameter and the distance b is in this case a second geometry parameter. Both geometry parameters or both distances a, b are corrected in the manner already described above with a term dependent on the cutting gas signal 63 or on the pressure p of the cutting gas. To determine the focal position, the evaluation device 80 preferably determines an average value from the two corrected geometry parameters aₖₒᵣᵣ, bₖₒᵣᵣ:

$${m}_{k o r r} = ( {a}_{k o r r} + {b}_{k o r r} ) / 2$$

The focal position is then determined according to the formula explained above:

$$Δ {z}_{F} = g ( {z}_{Koll} ) {m}_{k o r r} - {z}_{0}$$

This further development of the invention is particularly suitable for use on a processing optics 100, in which a first sample beam 70 is generated by reflection at a first boundary surface of the protective glass, for example the outer boundary surface 121 of the protective glass 120, and a second sample beam 170 is generated by reflection at a second boundary surface of the protective glass, for example the inner boundary surface 122 of the protective glass 120, and both sample beams 70, 170 are decoupled from the processing optics 100 by means of the beam decoupler 115 and are radiated into the beam analysis device 10. Surprisingly, it has been found that in such a constellation, a thermal focus shift of the entire processing optics as well as a thermal focus shift of only the protective glass with approximately the same sensitivity is included in the mean value m or mₖₒᵣᵣ, which is formed from the two distances a and b between the beam spots 93, 94 and 193, 194. The use of the mean value m or mₖₒᵣᵣ to determine the focal position is therefore particularly advantageous because the accuracy of the focal position determination is not dependent on the location of the formation of a thermal focus shift and the focal position determination is therefore particularly accurate and reliable overall.

The evaluation device 80 can also be configured to calculate an average value m from the first distance a and the second distance b according to the formula m=(a+b)/2, and to use this average value m as a geometry parameter for determining the focal position. In this case, the geometry parameter is corrected using a term dependent on the cutting gas signal 63 or the pressure p of the cutting gas after the mean value m has been calculated from the distances a and b.

Alternatively or in addition to determining the mean value m from the two distances a and b between the beam spots 93, 94 and 193, 194, the evaluation device 80 can be configured to determine a first mean position from the beam spots 93 and 193, to determine a second mean position from the beam spots 94 and 194, and to calculate a distance m in the first lateral direction 31 between the first mean position and the second mean position. Here, the beam spots 93 and 193 for the first mean position are formed by the partial beams which are extracted from the two sample beams 70 and 170 by the first transmission zone 23 of the modulation device 20, and the beam spots 94 and 194 for the second mean position are formed by the two partial beams which are extracted from the sample beams 70 and 170 by the second transmission zone 24 of the modulation device 20. Of course, the result of this determination of the distance m from the mean positions is identical to the mean value m which can be determined from the two distances a and b between the beam spots 93, 94 and 193, 194. Consequently, the distance m determined in this way can also be used as a geometry parameter for determining the focal position. The advantage of this alternative determination of the value m as a geometry parameter is that the beam spots 93 and 193 as well as the beam spots 94 and 194 do not have to be spatially separated from each other for the determination of the mean positions. In other words, with this type of evaluation, beam spots 93 and 193 may overlap partially or completely. The beam spots 94 and 194 can also overlap. A partial overlap of the beam spots can occur, for example, if the axial distance from the intermediate focus 71 of the first sample beam 70 to the intermediate focus 171 of the second sample beam 170 is relatively small. This type of evaluation is therefore particularly advantageous when used on processing optics with a thin protective glass. A thin protective glass can, for example, have a thickness of typically 1.5 mm. In contrast, protective glasses, in particular if they are to be suitable for higher cutting gas pressures, typically have a thickness of more than 3 mm.

In still a further embodiment of the invention, the evaluation means 80 may be arranged to determine a distance c between the beam spots 93 and 193 which are extracted from the two sample beams 70 and 170 by the first transmission zone 23 of the modulation device 20, and further a substantially equal distance c between the beam spots 94 and 194 which are extracted from the sample beams 70 and 170 by the second transmission zone 24 of the modulation device 20. FIG. 21 shows the distance c together with the other geometric relationships between the positions of the beam spots 93, 94, 193, 194. The distance c can be determined by the evaluation device 80 in particular by calculating the difference between the two distances a and b between the beam spots 93, 94 and 193, 194, according to the formula c=(a−b)/2. The value of this parameter c is directly related to the axial distance between the intermediate focus 71 of the first sample beam 70 and the intermediate focus 171 of the second sample beam 170, i.e. the axial focus distance between the two sample beams 70, 170. This axial focus distance depends on the one hand on the thickness of the protective glass and on the other hand on the thermal focus shift within the protective glass. This axial focus distance and thus the parameter c is almost independent of other influences. The parameter c is therefore particularly suitable for determining the level of the thermal focus shift of the protective glass alone. The evaluation device 80 can therefore also be configured to output a signal if a predetermined value for the parameter c is exceeded, which thus indicates that a predetermined thermal shift of the protective glass has been exceeded. Such a signal can be used in particular to indicate a necessary change of a contaminated protective glass.

The beam analysis device 10 according to the invention can also be used advantageously on a processing optics 200 in which two protective glasses 120, 125 are arranged one behind the other in the beam direction, and in which a pressure equalization connection 145 is provided in the cutting device 140 between the cavity 141 and the intermediate space between the two protective glasses, so that no differential pressure is exerted on the outer protective glass 120. Such a configuration of a processing optics 200 is shown in FIG. 23. This outer protective glass 120 facing the processing process therefore does not have to be pressure-resistant and a thin, correspondingly less expensive protective glass can therefore be used as a wear part. This type of arrangement with two protective glasses 120, 125 and a pressure equalization connection 145 also has the consequence that no deflection occurs in the outer protective glass 120 as a result of the cutting gas pressure p.

Consequently, there is also no displacement of the intermediate focus 71 in the sample beam 70 as a result of deflection of the protective glass. Nevertheless, a correction dependent on the cutting gas pressure p is required when determining the focal position, because the energy beam focus 76 is shifted as a result of the increase in the refractive index of the pressurized cutting gas. Thus, the beam analysis device 10 according to the invention enables a particularly accurate determination of the focal position even in the case of processing optics without deflection of the outer protective glass due to the consideration of the cutting gas.

One advantage of the invention lies in the fact that changes in the focal position caused by a process gas or a cutting gas, in particular under varying and/or high pressure, are compensated for by taking a cutting gas signal into consideration when determining the focal position, and in this way a significantly more accurate and reliable determination of the focal position is achieved during an ongoing processing process.

A further advantage of the invention, in particular in connection with a focal position sensor 13 according to the fourth described embodiment of the focal position sensor, is that the measuring principle of the beam analysis device 10 is based on the determination of positions of beam spots 93, 94 on the detector 40 which are delimited from one another. The position of a beam spot can be determined, for example, by calculating the centroid of the associated intensity distribution, i.e. the 1st moment of an intensity distribution. The determination of positions and their distance from each other is largely independent of, for example, the height of a constant signal background, which can be caused by scattered light and/or sensor noise. As a result, the measuring principle is less error-prone than other methods that are based, for example, on the determination of a beam diameter, i.e. the 2nd moment of an intensity distribution, and its change, because the determination of a 2nd moment is relatively sensitive to changes in the height of the background.

A further significant advantage of the invention is that the determination of the axial position of the beam focus is not influenced by fluctuations in the beam quality of the laser beam or the sample beam.

The determination of changes in the axial position of the beam focus is possible almost in real time, i.e. the determination requires only a fraction of the typical time constant of focal position changes caused by the thermal focus shift. The invention is therefore also able to provide signals for controlling the laser material processing process during a laser processing process. The processing process can be controlled, for example, by continuously readjusting or correcting the axial focal position of the processing optics.

A beam of electromagnetic radiation with a wavelength in the range from 0.1 μm to 10 μm, particularly preferably in the range from 0.3 μm to 3 μm, and especially in the range from 0.3 μm to 1.5 μm, is preferably regarded as an energy beam within the meaning of this disclosure.

For the purposes of this disclosure, laser radiation is preferably electromagnetic radiation in the range from 0.3 μm to 1.5 μm and with a power of at least 1 mW, particularly preferably with a power of at least 100 W. LIST OF THE REFERENCE SIGNS
10 Beam analysis device
11 optical axis, local optical axis
12 beam shaping device
13 focal position sensor
19 plane of the partial beam extraction
20 modulation device
23, 24 transmission zones
25 blocking zone
31 first lateral direction
33, 34 partial aperture
37 second lateral direction
39 sensor plane
40 detector
49 position of the imaging device, principal plane of the imaging device
50 imaging device
51 optical lens
52 beam separator device
53, 54 partial beam deflector elements, e.g. wedge plates, prisms or plane-parallel plates
56 lens array
57 individual lens element, lenslet
62 gas pressure sensor
63 (data connection for) cutting gas signal
64 (data connection for) detector signal
65 (data connection for) lens position signal
67 (data connection for) focus tracking signal
70 sample beam
71 focus of the sample beam (intermediate focus)
73, 74 partial beam
76 energy beam focus
77 energy beam or laser beam
79 intensity distribution on the detector
80 evaluation device
81 memory unit
83 input unit for cutting gas signals
84 input unit for detector signals
85 input unit for lens position signals
86 calculation unit
87 output unit for focus tracking signals
91 beam spot
93, 94 beam spots
100 laser processing optics
105 positioning device
110 optical fiber end
111 optical axis
113 collimator
114 decoupling device
115 beam decoupler
116 focusing optics
120 optical element, e.g. protective glass
121 outer boundary surface of the optical element
122 second boundary surface of the optical element
125 second protective glass
140 cutting gas device
141 cavity of the cutting gas device
142 outlet opening of the cutting gas device
143 cutting gas supply
145 pressure equalization connection
146 cutting gas
150 workpiece
170 second sample beam
171 focus of the second sample beam (second intermediate focus)
173, 174 further partial beams
193, 194 further beam spots
200 laser processing optics

1. Beam analysis device (10) for determining an axial position of a focus (76) of an energy beam (77) of electromagnetic radiation guided in laser processing optics (100), comprising a focal position sensor (13) and an evaluation device (80),
wherein the focal position sensor (13) comprises a beam shaping device (12) and a detector (40),
wherein the beam shaping device (12)
is configured to receive a sample beam (70), and
is configured to image at least part of the sample beam (70) onto the detector (40) by means of the beam shaping device (12) in order to form an intensity distribution (79) on the detector (40),
wherein the detector (40)
comprises a sensor which is sensitive to light radiation and has a two-dimensional spatial resolution and which is configured to convert the intensity distribution (79) incident on the detector (40) into electrical signals (64),
and wherein the evaluation device (80)
is configured to process the electrical signals (64) of the detector (40) which represent the intensity distribution (79) on the detector (40),
is configured to determine a geometry parameter from the intensity distribution (79),
is configured to receive a cutting gas signal (63) which represents a pressure of a process gas or a cutting gas,
is configured to determine a correction value taking into consideration the cutting gas signal (63), and
is configured to determine the axial position of the focus (76) of the energy beam (77), taking into consideration the geometry parameter and the correction value.

2. Beam analysis device (10) according to claim 1, wherein
the sample beam (70) can be generated by back-reflection of a fraction of the energy beam (77) at a boundary surface (121) of an optical element (120) of the laser processing optics (100),
the optical element (120) is adjacent to a cavity (141) of a cutting gas device (140) of the laser processing optics (100),
the sample beam (70) can be decoupled from the laser processing optics (100) by means of a beam decoupler (115) and can be fed to the beam shaping device (12) of the beam analysis device (10), and wherein
the cutting gas signal (63) represents a current pressure of a process gas or cutting gas

(146) in the cavity (141) of the cutting gas device (141).

3. Beam analysis device (10) according to claim 2, wherein the beam shaping device (12) and the detector (40) are arranged together in a housing which has an opening for introducing the sample beam (70), and wherein the housing can be connected to the laser processing optics (100), so that the sample beam (70) which can be decoupled by means of the beam decoupler (115) can be fed to the beam shaping device.

4. Beam analysis device (10) according to any one of the preceding claims, wherein the evaluation device (80) comprises an input unit (83) for the cutting gas signal (63), an input unit (84) for the detector signal (64), a memory unit (81), and a calculation unit (86).

5. Beam analysis device (10) according to any one of the preceding claims, wherein the evaluation device (80) is configured to carry out the determination of the correction value taking into consideration calibration data which are stored in the memory unit (81), wherein the calibration data describe a change in the geometry parameter as a function of the cutting gas signal (63).

6. Beam analysis device (10) according to one of the preceding claims, wherein the evaluation device (80)
is configured to receive a lens position signal (65) representing the axial position of an axially positionable lens or lens group of the laser processing optics (100), and
is configured to determine the axial position of the focus (76) of the energy beam (77), taking into consideration the geometry parameter, the correction value and the lens position signal (65).

7. Beam analysis device (10) according to claim 6, wherein the evaluation device (80) comprises an input unit (85) for the lens position signal (65).

8. Beam analysis device (10) according to any one of the preceding claims, wherein the evaluation device (80) is
is configured to calculate a focus tracking signal (67) from the determined axial position of the focus (76) of the energy beam (77), which is a focus actual position, and from a focus target position, and
is configured to output the focus tracking signal (67), which is transferred directly or via a higher-level control device to a positioning device (105), by means of which a position of an axially positionable lens of the laser processing optics (100) can be adjusted.

9. Beam analysis device (10) according to claim 8, wherein the evaluation device (80) comprises an output unit (87) for the focus tracking signal (67).

10. Beam analysis device (10) according to any one of the preceding claims, wherein the beam shaping device (12) comprises an imaging device (50) with at least one optical lens (51).

11. Beam analysis device (10) according to any one of the preceding claims, wherein
the beam shaping device (12) is configured to image the sample beam (70) onto the detector (40) and to form the intensity distribution (79) on the detector (40) with a beam spot (91) having a diameter Ø, and wherein
the determination of the geometry parameter by the evaluation device (80) comprises a determination of the diameter Ø of the beam spot (91) on the detector (40).

12. Beam analysis device (10) according to any one of claims 1 to 10, wherein
the beam shaping device (12) comprises a lens array (56) for imaging the sample beam (70) onto the detector (40) and for forming the intensity distribution (79) on the detector (40) with a plurality of beam spots having distances a_{N1}, a_{N2}, . . . a_{NM} from one another, and wherein
the determination of the geometry parameter by the evaluation device (60) comprises a determination of at least one of the distances a_{N1}, a_{N2}, . . . a_{NM} of the beam spots from one another.

13. Beam analysis device (10) according to any one of claims 1 to 10, wherein the beam shaping device (12)
comprises a modulation device (20) for extracting two partial beams (73, 74) from the sample beam (70),
is configured to image the two partial beams (73, 74) onto the detector (40) for forming the intensity distribution (79) on the detector (40) with beam spots (93, 94) which have a distance a from one another, and
wherein the determination of the geometry parameter by the evaluation device (80) comprises a determination of the distance a of the beam spots (93, 94) from one another.

14. Beam analysis device (10) according to one of claims 1 to 10, wherein the beam shaping device (12)
is configured to extract two partial beams (73, 74) from the sample beam (70) in a plane of the partial beam extraction (19), wherein the two partial beams (73, 74) are a first partial beam (73) and a second partial beam (74), wherein cross-sections of the two partial beams (73, 74) in the plane of the partial beam extraction (19) are each defined by a partial aperture (33, 34), wherein the partial apertures (33, 34) are delimited from one another and centers of the partial apertures (33, 34) have a distance k from one another, wherein a first lateral direction (31) is defined by the distance k of the partial apertures (33, 34), wherein the term “lateral” refers to directions in planes perpendicular to the respective local optical axis (11),
is configured to image the two partial beams (73, 74) onto the detector (40) in order to form the intensity distribution (79) on the detector (40) with beam spots (93, 94) and to each form at least one beam spot (93) from the first partial beam (73) and at least one beam spot (94) from the second partial beam (74);
wherein the detector (40) is arranged along a propagation path for the partial beams (73, 74) at a distance s behind the plane of the partial beam extraction (19); and
wherein the determination of the geometry parameter by the evaluation device (80) comprises a determination of a distance a along the first lateral direction (31) between positions of the two beam spots (93, 94) on the detector (40).

15. Beam analysis device (10) according to claim 14, wherein the beam shaping device (12) is configured to deflect and/or displace at least one of the at least two partial beams (73, 74) in a second lateral direction (37) to form a distance w along the second lateral direction (37) between the two beam spots (93, 94) on the detector (40), wherein the second lateral direction (37) is oriented transversely to the first lateral direction (31).

16. Beam analysis device (10) according to claim 14 or 15, wherein the first lateral direction (31) and the local optical axis (11) between the plane of the partial beam extraction (19) and the detector (40) are changed by beam folding and/or beam deflection.

17. Beam analysis device (10) according to one of claims 14 to 16, wherein the beam shaping device (12) is configured to deflect and/or displace the two partial beams (73, 74) relative to one another, wherein a difference between the deflections and/or displacements of the two partial beams (73, 74) is aligned along the second lateral direction (37), for forming the distance w along the second lateral direction (37) between the two beam spots (93, 94) on the detector (40).

18. Beam analysis device (10) according to any one of claims 14 to 17, wherein the beam shaping device (12) comprises a beam separator device (52) with at least one partial beam deflector element (53, 54) for deflecting and/or displacing a first one of the at least two partial beams (73, 74) in the second lateral direction (37) for forming the distance w along the second lateral direction (37) between the two beam spots (93, 94) on the detector (40).

19. Beam analysis device (10) according to claim 18, wherein the beam separator device (52) comprises at least two partial beam deflector elements (53, 54) for deflecting and/or displacing the two partial beams (73, 74) relative to one another, wherein a difference between the deflections and/or displacements of the two partial beams (73, 74) is aligned along the second lateral direction (37), for forming the distance w along the second lateral direction (37) between the two beam spots (93, 94) on the detector (40).

20. Beam analysis device (10) according to one of claims 18 or 19, wherein the beam separator device (52) includes at least one wedge plate (53, 54) as a partial beam deflector element, which is arranged in alignment with the beam direction in front of or behind one of the partial apertures (33, 34), and which is configured to deflect the partial beam (73, 74) extracted from the partial aperture (33, 34) by an angular amount in the range from 0.02° to 6°.

21. Beam analysis device (10) according to one of claims 18 to 20, wherein the beam separator device (52) includes at least one tilted plane-parallel plate (53, 54) or a prism as a partial beam deflector element, which is arranged in alignment with the beam direction in front of or behind one of the partial apertures (33, 34), and which is configured to displace the partial beam (73, 74) released from the partial aperture (33, 34) by an amount in the range from 0.05 mm to 3 mm.

22. Beam analysis device (10) according to any one of the preceding claims, wherein the evaluation device (80) is further configured to determine a lateral position of the overall intensity distribution (79) on the detector (40) and is configured to calculate a lateral position of the focus (76) of the energy beam (77) from the lateral position of the overall intensity distribution (79) and/or to calculate a change in the lateral position of the focus (76) of the energy beam (77) from a change in the lateral position of the overall intensity distribution (79).

23. System comprising a beam analysis device (10) according to any one of the preceding claims and laser processing optics (100) for guiding and focusing the energy beam (77), wherein the processing optics (100) comprises a beam decoupler (115) for decoupling the sample beam (70), and wherein the beam analysis device (10) is connectable to the processing optics (100) for receiving the decoupled sample beam (70).

24. A method for determining an axial position of a focus (76) of an energy beam (77) of electromagnetic radiation guided in laser processing optics (100), comprising the following steps:
receiving a sample beam (70) decoupled from the laser processing optics (100),
imaging at least a part of the sample beam (70) onto a detector (40) by means of a beam shaping device (12) in order to form an intensity distribution (79) on the detector (40),
converting the intensity distribution (79) incident on the detector (40) into electrical signals (64) by means of a sensor of the detector (40) which is sensitive to light radiation
and has a two-dimensional spatial resolution,
processing the electrical signals (64) of the detector (40), which represent the intensity distribution (79) on the detector (40),
determining a geometry parameter from the intensity distribution (79),
receiving a cutting gas signal (63) representing a pressure of a process gas or cutting gas (146),
determining a correction value taking into consideration the cutting gas signal, and
determining the axial position of the focus (76) of the energy beam (77), taking into consideration the geometry parameter and the correction value.

25. The method according to claim 24, comprising the further method steps:
generating the sample beam (70) by back-reflecting a fraction of the energy beam (77) at a boundary surface (121) of an optical element (120) of the laser processing optics (100), wherein the optical element (120) is adjacent to a cavity (141) of a cutting gas device (140) of the laser processing optics (100),
decoupling the sample beam (70) from the laser processing optics (100) by means of a beam decoupler (115), and
feeding the decoupled sample beam (70) to the beam analysis device (10).

26. The method according to claim 24 or 25, comprising the step of: determining the correction value taking into consideration calibration data, wherein the calibration data describes a change in the geometry parameter as a function of the cutting gas signal (63).

27. The method according to any one of claims 24 to 26, comprising the steps of:
receiving a lens position signal (65) representing the axial position of an axially positionable lens or lens group of the laser processing optics (100), and
determining the axial position of the focus (76) of the energy beam (77), taking into consideration the geometry parameter, the correction value, and the lens position signal (65).

28. The method according to any one of claims 24 to 27, comprising the steps of:
calculating a focus tracking signal (67) from the determined axial position of the focus (76) of the energy beam (77), which is a focus actual position, and from a focus target position, and
providing and transferring the focus tracking signal (67) to a positioning device (105), by means of which a position of an axially positionable lens or lens group of the laser processing optics (100) can be adjusted.
